(19) United States
(12) Patent Application Publication
(10) Pub. No.: US 2021/0019687 A1
(43) Pub. Date: Jan. 21, 2021

(54) MANAGER AUGMENTATION SERVER AND SYSTEM

(71) Applicant: PULSIFY, INC., Wellesley, MA (US)

(72) Inventors: Bennett Alexander Fisher, Wellesley, MA (US); Paul Joseph Gagne, Reading, MA (US); Adam Kernander, Dover, NH (US)

(21) Appl. No.: 16/931,222

(22) Filed: Jul. 16, 2020

Related U.S. Application Data
(60) Provisional application No. 62/874,807, filed on Jul. 16, 2019.

(51) Int. Cl. G06Q 10/06; G06N 20/00

(52) U.S. Cl. CPC G06Q 10/06398; G06N 20/00; G06Q 10/063114; G06Q 10/0637; G06Q 10/06393

(57) ABSTRACT

In some embodiments, the manager augmentation system is directed to a system for empowering virtual, high performing teams by driving more effective communication and alignment. In some embodiments, the system includes a portal user interface that displays goals, real time feedback, sentiment, and performance related information and accepts both manager and employee input about the current state each of those items. In some embodiments, the system provides analytics using machine learning to track changes across each of those items and identify where employees may be in need of support, are at risk of leaving, or are misaligned with their manager. In some embodiments, the system uses the analytics and inputs to determine and prompt actions related to best practices so that managers can improve their engagement and execution with their team. In some embodiments, the system uses algorithms to calculate a Net Manager Score that quantifies how that manager is performing.

### CROSS REFERENCE

This application claims the benefit of U.S. Provisional Patent Application No. 62/874,807, filed Jul. 16, 2019, the entire contents of which are incorporated herein.

### BACKGROUND

Most managers struggle at managing. Even the really good ones. And one way to make them struggle more is having them manage a virtual team. Yet that's the new reality for most managers today. They all want aligned, high performing teams even if everyone is working from a bedroom or garage. Managers at every level feel this pain more deeply than ever before. Training might help, but it is a moment in time, not a constant presence during the workday. It's a lesson, not a coach. And training takes time and is expensive, so most companies don't do it. And so winging it becomes endemic. Managers at every level suffer from such a manager proficiency gap. It leads to low productivity, attrition and lost opportunities. Any manager with a proficiency gap will underperform a manager that improves the daily management of their team by even a little. There are companies that offer software that's supposed to help with management. Most sell performance and engagement tools that give a company a way to see where problems lie. But those are just measurement tools and implementing and configuring these complex systems takes an HR team, IT, and consultants. They don't fix the manager proficiency gap.

Manager augmentation is a cloud-based, always-there, team management coach. It is a virtual-first management system that can help any manager in any setting, including a traditional office, be more efficient and effective, so their jobs are easier and more rewarding. Manager augmentation guides managers through a continuous process built on proven management practices such as goal setting, 1-on-1s, ongoing feedback and more—including special insights about how to be effective when remote. The software learns and dynamically understands a team members strengths, weaknesses, and challenges. It creates alerts and nudges to help a manger drive an effective and individualized process that surfaces problems and successes. As needed, the platform finds and collects instructive content from the best management publications. If the manager needs to boost an underperforming employee, the software finds the right material that can provide insights. Importantly, manager augmentation can have an immediate and continuous impact. It can help both a traditional and virtual manager from day one. It can spot team members with problems and misalignment—or reveal a star performer ready for bigger challenges—up and down an organization. Because it is simple and lightweight, any manager can adopt it as seamlessly as signing up for an email account. And the simplicity makes actionable analytics possible. In coming years, the system will pull in third-party data too, perhaps watching LinkedIn or Glassdoor to help with predictive insights. Leveraging machine learning will allow the app to require less input from managers. Information will flow in from online interactions, company documents, emails, texts and collaboration tools such as Slack. The system can morph as we find new ways or places to work. It can be built into chatbots, voice systems like Alexa, or anything else that comes along. Over time, the AI can come to understand individual managers and their teams. The better it knows you, the better it can advise and guide you.

### DESCRIPTION OF THE DRAWINGS

FIG. 1A illustrates a manager sentiment display in accordance with some embodiments of the invention.

FIG. 1B illustrates an extension of the manager sentiment display of FIG. 1A in accordance with some embodiments of the invention.

FIG. 2 illustrates an employee sentiment screen in accordance with some embodiments of the invention.

FIGS. 3A-3B and 4A-4B illustrate employee sentiment displays accordance with some embodiments of the invention.

FIG. 5 illustrates a team dashboard or display in accordance with some embodiments of the invention.

FIG. 6 illustrates an individual employee's display in accordance with some embodiments of the invention.

FIG. 6A illustrates a sentiment trend chart in accordance with some embodiments of the invention.

FIG. 6B illustrates a sentiment distribution chart in accordance with some embodiments of the invention.

FIG. 6C illustrates a cumulative reasons chart in accordance with some embodiments of the invention.

FIG. 6D illustrates a reasons trend chart in accordance with some embodiments of the invention.

FIGS. 6E-6F illustrate at-risk trend charts in accordance with some embodiments of the invention.

FIGS. 6G-6H illustrate misaligned trend charts in accordance with some embodiments of the invention.

FIG. 61 illustrates an assessment trends chart a in accordance with some embodiments of the invention.

FIG. 7 illustrates a service component architecture of the manager augmentation server and system in accordance with some embodiments of the invention.

FIG. 8 illustrates a computing system configured for processing the manager augmentation server and system in accordance with some embodiments of the invention.

FIG. 9 shows a machine learning for an at-risk employee architecture of the manager augmentation Server and System in accordance with some embodiments of the invention.

FIG. 10 shows a software component architecture of the manager augmentation server and system in accordance with some embodiments of the invention.

FIG. 11 illustrates a dashboard display according to some embodiments of the invention.

FIG. 12 illustrates a goal setting display page according to some embodiments of the invention.

FIG. 13 illustrates a set goals display page according to some embodiments of the invention.

FIGS. 14-15 illustrate goal approval display pages according to some embodiments of the invention.

FIG. 16 illustrates a goal review display page according to some embodiments of the invention.

FIGS. 17A-17G illustrate display pages related to feedback in accordance with some embodiments of the invention.

FIG. 18 illustrates a sentiment or rating by time chart according to some embodiments of the invention.

FIG. 19 illustrates a reasons listing display page according to some embodiments of the invention.

FIG. 20 illustrates a misalignment distribution display page according to some embodiments of the invention.

FIG. 21 illustrates an at-risk distribution display page according to some embodiments of the invention.

FIG. 22 illustrates a sentiment usage display page according to some embodiments of the invention.

FIG. 23-28 illustrate progress and review display pages according to some embodiments of the invention.

FIG. 29 illustrates a direct reports display page according to some embodiments of the invention.

FIG. 30 illustrates a dashboard display page according to some embodiments of the invention.

FIG. 31 illustrates a tracking and metrics display page according to some embodiments of the invention.

FIG. 32 illustrates a summary and performance distribution display page according to some embodiments of the invention.

FIG. 33 illustrates a high and low performing employee display page according to some embodiments of the invention.

FIGS. 34-35 illustrate review display pages according to some embodiments of the invention.

FIG. 36 illustrates a performance usage display page according to some embodiments of the invention.

FIGS. 37-38 illustrate goal overview display pages according to some embodiments of the invention.

FIG. 39 illustrates a manage surveys display page according to some embodiments of the invention.

FIG. 40 illustrates a scoring and performance statistics display page according to some embodiments of the invention.

FIG. 41 illustrates a Things To Do display page according to some embodiments of the invention.

FIG. 42 illustrates a Net Manager Score™ according to some embodiments of the invention.

FIG. 43 illustrates a Net Manager Score Benchmark which shows how a manager's score changes over time and compares it to the average of the company according to some embodiments.

FIG. 44 illustrates a Net Manager Score Leaderboard which shows the top 10 managers with the highest NMS score according to some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein, have many useful alternatives, and fall within the scope of embodiments of the invention.

Unless specified or limited otherwise, as used herein, the term “company” defines a set of employees or independent contractors affiliated with an organization and/or who share the same email domain (e.g., such as google.com). Google® is a registered trademark of Google Inc., of Mountain View, Calif. Employees are typically organized into teams with a team having a manager (also referred to as a team lead). As used herein, the manager is a person who has been identified by the company to lead a group of employees or independent contractors or is a user of professional or other services. In some embodiments, the manager can be a direct manager, and in some other embodiments, the manager can be an indirect manager. In some embodiments, the manager and employee can be employees of a company or entity. In other embodiments, the manager can be a non-employee consultant or other independent contractor of the company or entity. In some further embodiments, the employee can be a temporary employee. In some embodiments, an employee is a person working for the company who possesses an email account with the company's email domain. Unless specified or limited otherwise, a team consists of a manager and employees who are their direct reports. As used herein, one or more employees on a team may also be managers. Unless specified or limited otherwise, the term “directs” refers to employees that report directly to at least one manager. Unless specified or limited otherwise, the term “peers” refers to managers at the same organizational level as the manager reporting to the same manager or managers. Unless specified or limited otherwise, any described organization consists of a team and all of the members of subordinate teams. Unless specified or limited otherwise, the term “assessment” refers to an activity performed on a regular periodic basis (e.g. every week) by the manager with each of the employees on his or her team with the main purpose of assessing overall employee disposition and supporting reasons across multiple dimensions.

Unless specified or limited otherwise, in some non-limiting embodiments, the results of a sentiment check can comprise of one or more of the following: the rating of overall employee disposition; one or more specific concerns selected from a list of supporting reasons; and free-form optional notes. Other embodiments can relate to action/times or next steps. Unless specified or limited otherwise, a rating can provide an overall assessment score that serves as a summary of the state of mind of an employee after a sentiment check. Unless specified or limited otherwise, a period is the frequency of check-ins, e.g. every week, every two weeks, monthly, etc. Unless specified or limited otherwise, a timeframe can be a start and end date range that defines a set of periods. Unless specified or limited otherwise, an authentication service can be a component within the service that provides user authentication.

Some embodiments include the manager augmentation server and system that uses software as a service platform (e.g., a “SaaS” platform) that is designed to help managers assess and monitor an employee's overall disposition, and/or provide the right amount of direction and support needed to maximize their on-going satisfaction and performance. In some embodiments, the manager augmentation server and system can foster better one-on-one communications leveraging and capturing regular check-ins, one-on-ones, an/or formal or informal discussions or meetings between managers and their employees, whether individual employees or direct reports, or with teams of employees or direct reports. Further, in some embodiments, the manager augmentation server and system can record the pulse of an organization as reflected by these sentiments, providing meaningful benchmarks and statistics across all levels of the organization. In some embodiments, the manager augmentation server and system can propose approaches, strategies, and/or specific actions for improvement at both the employee and organizational level, it can also enable an employee's manager to compare, assess, and/or triangulate whether his or her rating or assessment is aligned or not with an employee's rating or assessment. In other embodiments, the manager augmentation server and system can enable an employee's manager to compare, assess, and/or triangulate whether his or her rating or assessment provided by at least one other manager of the employee (e.g., in circumstances where the employee has more than one manager).

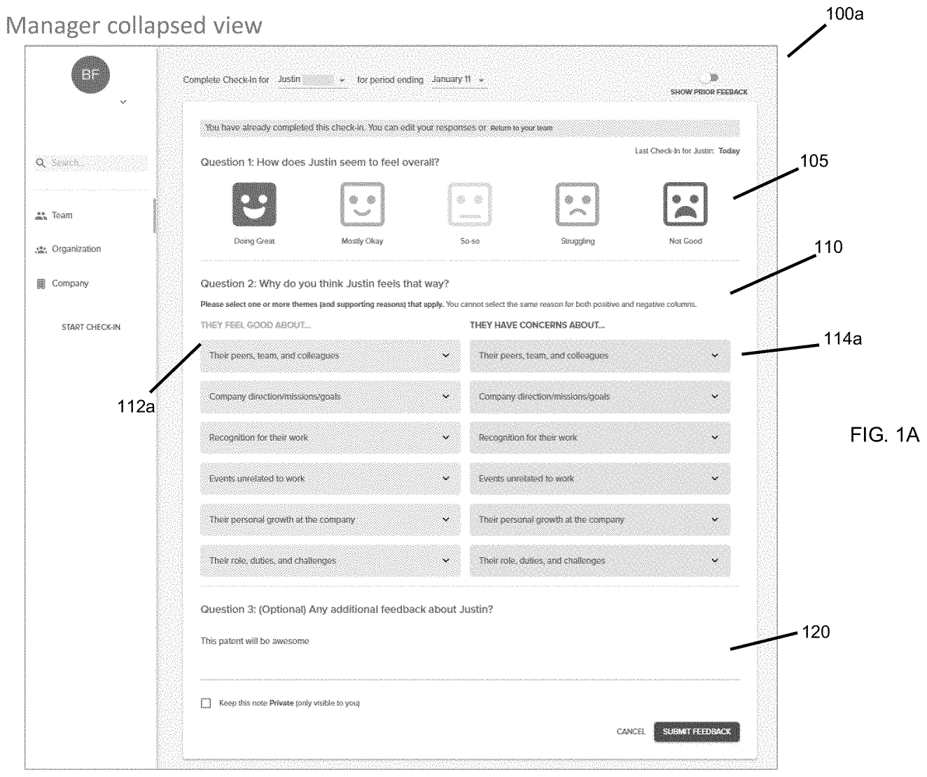

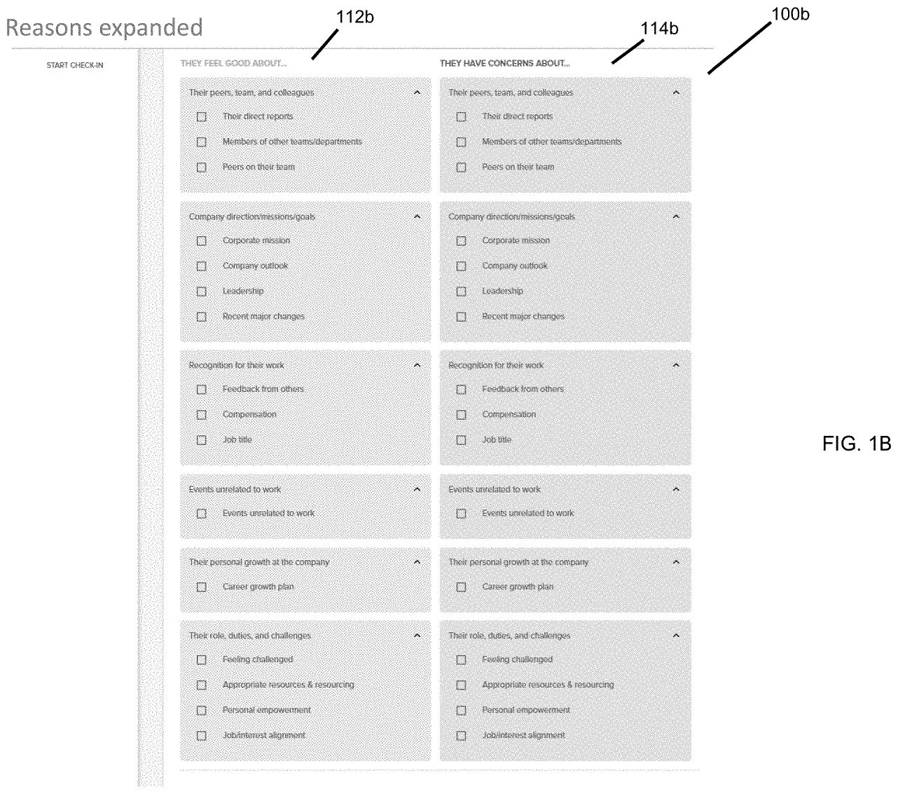

FIG. 1A illustrates a manager sentiment evaluation form or display 100a in accordance with some embodiments of the invention, and FIG. 1B illustrates an extension 100b of the manager sentiment evaluation form or display 100a of FIG. 1A in accordance with some embodiments of the invention. Some embodiments of the invention include a display portion or window structure 105 where the manager can select a sentiment rating related to or describing how he or she perceives an employee. Some embodiments of the invention include a display portion or window structure 110 where the manager can select a category and reason that best describes the employee sentiment rating selected. Some embodiments can include a display of selectable icons including, but not limited to, “doing great”, “mostly okay”, “so-so”, “struggling”, and “not good”. In some embodiments, an indicator of a prior rating or prior selected rating can be shown. In some embodiments, one or more reasons from a selection of positive reasons related to positive or neutral feelings (e.g., related to “doing great”, “mostly okay”, or “so-so”) can be displayed in a “they feel good about” column. In some other embodiments, one or more reasons from a selection of negative reasons related to negative feelings (e.g., related to “struggling”, or “not good”) can be displayed in a “they have concerns about” column.

In some embodiments, a rating, sentiment, or feeling can be signified using one or more colors of text and/or graphics or icons of a specific color or colors in the display portion or window structure 105. For example, in some embodiments, a rating can be a “red” rating text and/or graphic or icon indicating the employee is not good. In some further embodiments, a rating can be an “orange” text and/or graphics or icon indicative of an employee who is struggling. In some other embodiments, a rating can be a “yellow” text and/or graphic or icon indicative of an employee that is generally okay or so-so. In some embodiments of the invention, a rating can be a “light green” text and/or graphic or icon indicative of an employee who is mostly okay. In some further embodiments, the rating can be a “green” text and/or graphic or icon indicative of an employee who is doing great. In some embodiments, any color or combination of colors and any combination of text and/or graphics or icons can be used for a rating. Some embodiments can include descriptions that align with or have generally the same meaning as the above described ratings, sentiments, or feelings. Further, in some embodiments, the manager can use a notes portion 120 that can be used to provide additional information or comments regarding an employee.

In some embodiments, an overall rating is further qualified by one or more reasons that the manager can select. The reasons are important in that they provide a deeper understanding of any issues and trigger recommendations of approaches, strategies, and actions to help address them. In some embodiments, the reasons can be presented as a standard checklist organized into categories that address both positive and negative reasons for the rating given. In this way, an individual's and the overall organization's health can be assessed in both what is going well and what is not. In some embodiments, unless specified or limited otherwise, assessment reasons can be a categorized list of one or more reasons which qualify the assessment rating given or selected, where the manager can select one or more for each assessment. For example, in reference to the dashboard or display 100a and extension 100b, some embodiments comprise a display portion 110 that can include selectable answers to a question of why the manager thinks a specific way about an employee. In some embodiments, selectable answers in a positive category 112a can be related to what the employee feels good about, and selectable answers in a less positive, neutral, or negative category 114a are related to what the employee has concerns with. In reference to FIG. 1B, some embodiments comprise selectable answers in a positive category 112b that can be related to what the employee feels good about, and selectable answers in a less positive, neutral, or negative category 114b related to what the employee has concerns with. In both positive and negative categories, one or more reasons may be selected. In some embodiments, the same reason may not be selected as both positive and negative. In some embodiments, the sentiment reason is a positive or negative reason comprising their peers, team and colleagues, company direction, mission and/or goals, recognition for their work, events unrelated to work, their personal growth at the company, their role, duties, and challenges. In some embodiments, selectable responses to the positive or negative reason of peers, team and colleagues includes their direct reports, members of other teams or departments, and peers on their team. In some further embodiments, the selectable responses to the positive or negative reason of company direction, mission, and/or goals includes corporate mission, company outlook, leadership, recent major changes. In some other embodiments, the selectable responses to the positive or negative reason of recognition for their work includes feedback from others, compensation, and job title. In some embodiments, selectable responses to the positive or negative reason of events unrelated to work includes events unrelated to work. In some further embodiments, selectable responses to the positive or negative reason of their personal growth at the company includes a career growth plan. In some embodiments, the selectable responses to the positive or negative reason of their role, duties, and challenges includes feeling challenged, appropriate resources and resourcing, personal empowerment, and job or interest alignment.

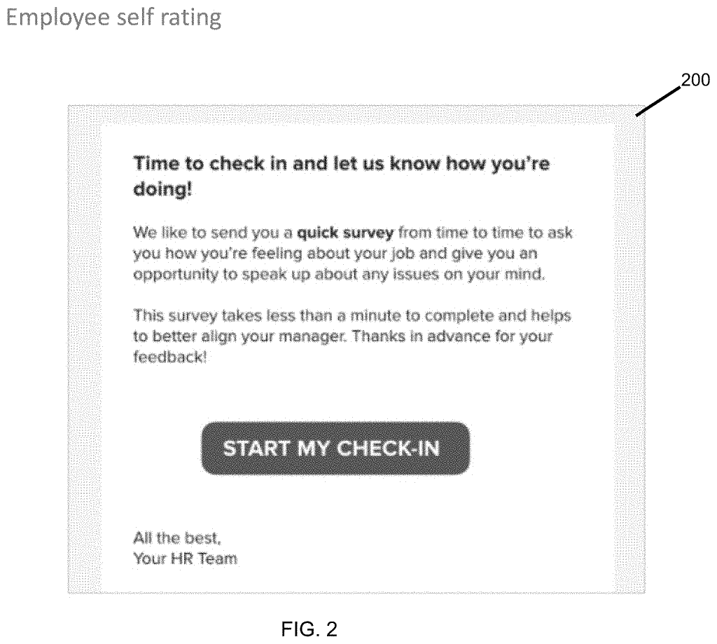

In some embodiments, the manager augmentation server and system can allow a relatively quick recording or viewing of periodic assessments (e.g., periodic assessments with a frequency of weekly, bi-weekly, etc.). For example, FIG. 2 illustrates an employee sentiment screen 200 in accordance with some embodiments of the invention. In some embodiments, an assessment form of the manager augmentation server and system can ask for a quick overall rating that captures overall employee disposition depicted on a spectrum of green (great) to red (not good), and represented as various shading densities, colors, graphics, icons, or combinations thereof. In some embodiments, the manager augmentation server and system can support multiple types of assessments. In some embodiments, the employee sentiment may be a display screen, email, push notification, text message or any notification service accessible by the manager. For example, in some embodiments, a manager assessment, assessments are performed by managers on their direct employees and summarized in the assessment overview.

In some embodiments, the manager augmentation server and system can support each employee having the ability to provide an employee sentiment check by providing their overall job satisfaction and primary reasons for their assessment. In some embodiments, the reason for doing this is to help the employee's manager and senior executives triangulate whether his or her rating is aligned or not. In some embodiments, the employee sentiment can be a similar, but abridged version of the manager sentiment, can be completed quickly, and is designed to solicit input that can be used by the employee's manager. In some embodiments, it is also designed to provide insight into an organization.

In some embodiments, employee sentiment checks can be optional, and an organization may choose to not present the option of an employee sentiment to its employees/managers. For example, some embodiments include an employee sentiment feature that is used to augment manager sentiments and allow employees to rate themselves in the same manner as managers (at some chosen frequency, e.g., such as every two weeks). In some embodiments, the data can be used to triangulate back to and check against the rating that the manager entered for that same employee. In some embodiments, when an employee provides a sentiment check, the manager augmentation server and system can utilize algorithms to compare how that assessment compares with the rating entered by the manager for that employee's overall status, and reasons, and whether the differences are significant enough to be brought to the manager's attention.

In some embodiments, augmenting the manager rating with an employee self-rating can help ensure that the manager accurately captures the overall sentiment of the employee without violating the confidentiality of the employee. In some embodiments, by independently collecting both the manager and employee ratings, the system creates a double-blind or substantially double-blind system, and determines misalignment very early, so that actions can be taken to improve it. Further, in some embodiments, the actions can be tailored not just to the individual person, but the specific reason of concern with an individual person.

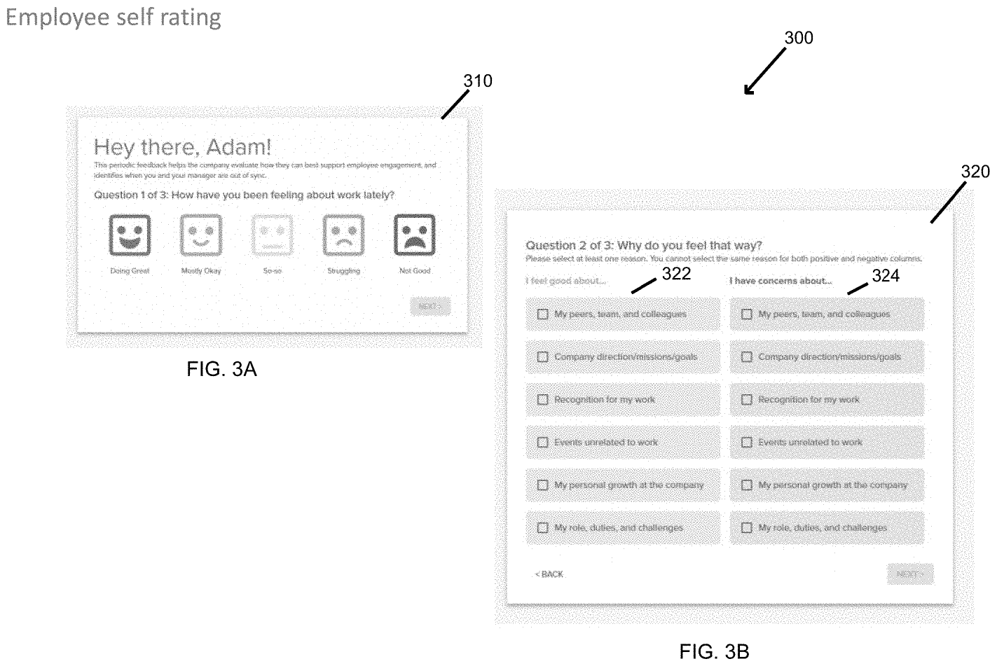

In some embodiments, a combination of the overall rating and the reasons selected can be used as inputs into the algorithms. In some embodiments, the employee sentiment displays of FIGS. 3A-B and/or 4A-B can be delivered to an employee with an email. In some embodiments, this can be initiated by a manager and/or the manager augmentation server and system. In some embodiments, the displays can be provided via an add-in. In some embodiments, any employee and/or manager, and/or team displays described herein can be delivered through, accessed from, or linked to an email program such as Microsoft® Outlook® and/or Google® Mail (Gmail®). Microsoft® and Microsoft® Outlook® are registered trademarks of Microsoft Corporation, Redmond, Wash.

In some embodiments, an employee sentiment check can be used to collect the employee's feelings about their job. In some embodiments, the system may use the evaluation entered by the manager and the one entered by the employee to determine a more accurate and comprehensive sentiment profile of the employee. In some embodiments, statistical analysis as well as machine learning techniques can be used to determine the sentiment profile. In some embodiments, one aspect of the sentiment profile is determined by a double-blind process or substantially double-blind process that compares the manager response to the employee reasons and ratings. In some embodiments, the manager and/or employee will be made aware of any misalignment and encouraged to discuss with each other. In some embodiments, the process is considered ‘double-blind’ because neither the manager or employee are made directly aware of the other's specific responses yet any misalignment is detected and surfaced between them.

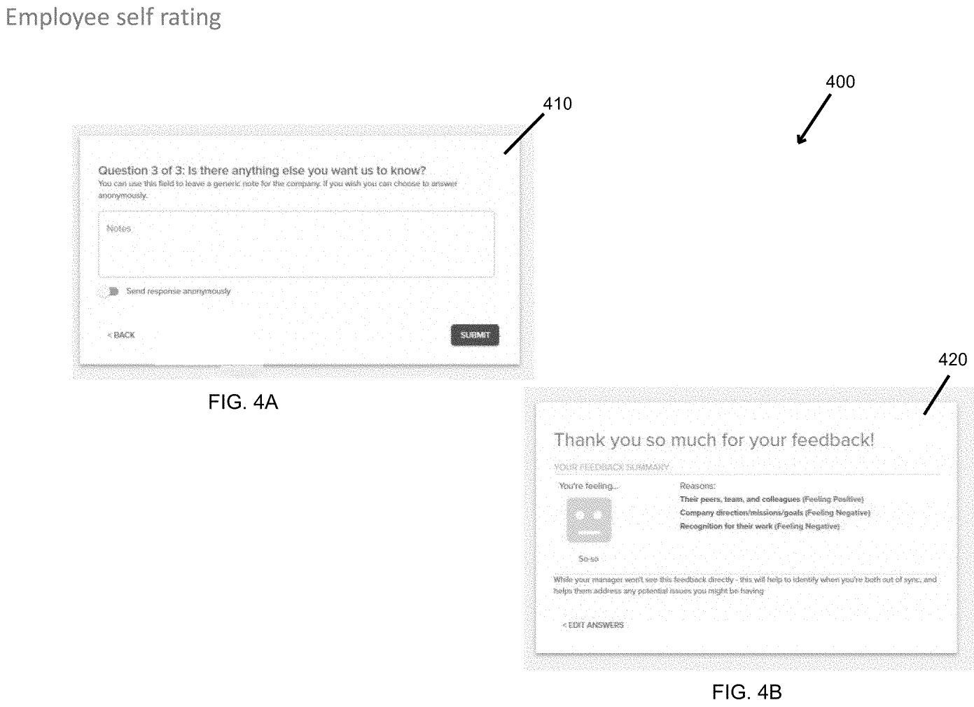

FIGS. 3A-4B illustrates an employee self-rating display 300, 400 in accordance with some embodiments of the invention. In some embodiments of the invention, the manager augmentation server and system can generate one or more displays that enables an employee to provide at least one check-in. For example, in some embodiments, the check-in can comprise a rating, sentiment, or feeling that can be signified using one or more colors of text and/or graphics or icons of a specific color or colors in the display portion or window 310. For example, as shown in some embodiments, the manager augmentation server and system generates a question asking how the employee feels, the display portion or window 310 can display a rating that can be a “red” rating text and/or graphic or icon indicating the employee is not good. In some further embodiments, a rating can be an “orange” text and/or graphics or icon indicative of the employee struggling. In some other embodiments, a rating can be a “yellow” text and/or graphic or icon indicative of the employee being so-so. In some embodiments of the invention, a rating can be a “light green” text and/or graphic or icon indicative of the employee being mostly okay. In some further embodiments, the rating can be a “green” text and/or graphic or icon indicative of the employee doing great. In some embodiments, any color or combination of colors and any combination of text and/or graphics or icons can be used for the employee self-rating display portion or window 310. Some further embodiments can include alternative descriptions that align with or have generally the same meaning as the above described ratings, sentiments, or feelings.

In some embodiments, the employee sentiment display 300 can comprise a display portion 320 that can include selectable reasons to a question of why the employee thinks or is feeling a specific way. For example, in some embodiments, selectable reasons in a positive category 322 can be related to what the employee is feeling good about, and selectable reasons in a less positive, neutral, or negative category 324 are related to where the employee has concerns. In some embodiments, the employee may not select both the positive and negative reasons of the same reason.

In reference to the employee sentiment display 400, some embodiments include a window portion 410 with a question asking if the employee has anything else to communicate, and includes a notes section where the employee has the option to provide more information. In some embodiments, the employee may choose to send their notes anonymously. In some embodiments the employee's anonymous notes may only be visible to the company. Further, a window portion 420 can include information reflecting the employee's check-in including a selected rating, sentiment, or feeling comprising text and/or graphics or icons of a specific color or colors as described earlier, and one or more selected reasons.

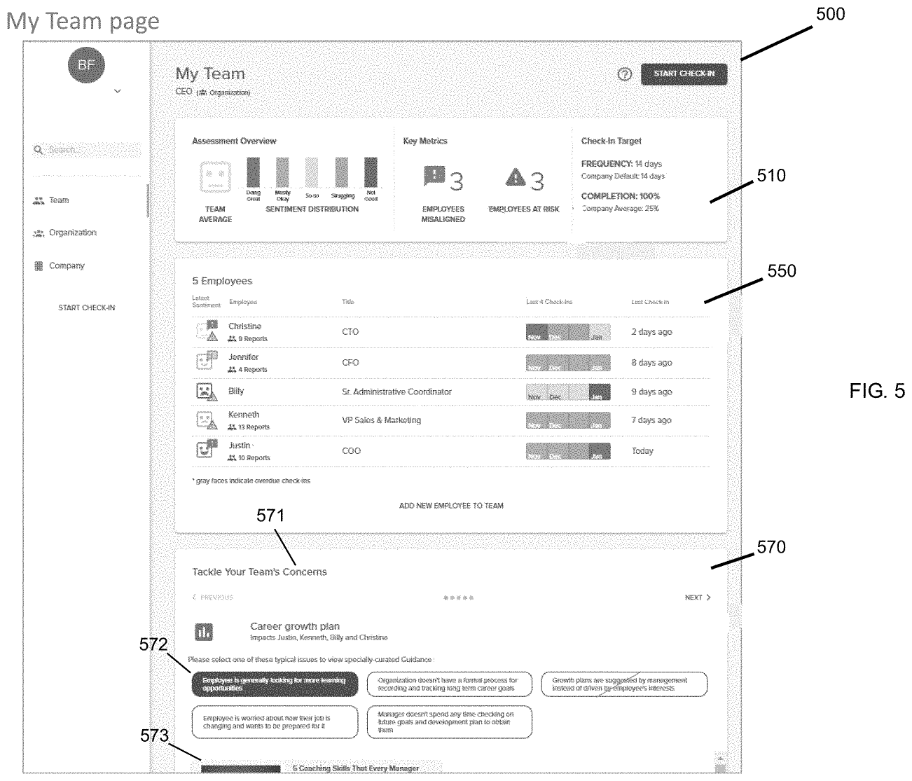

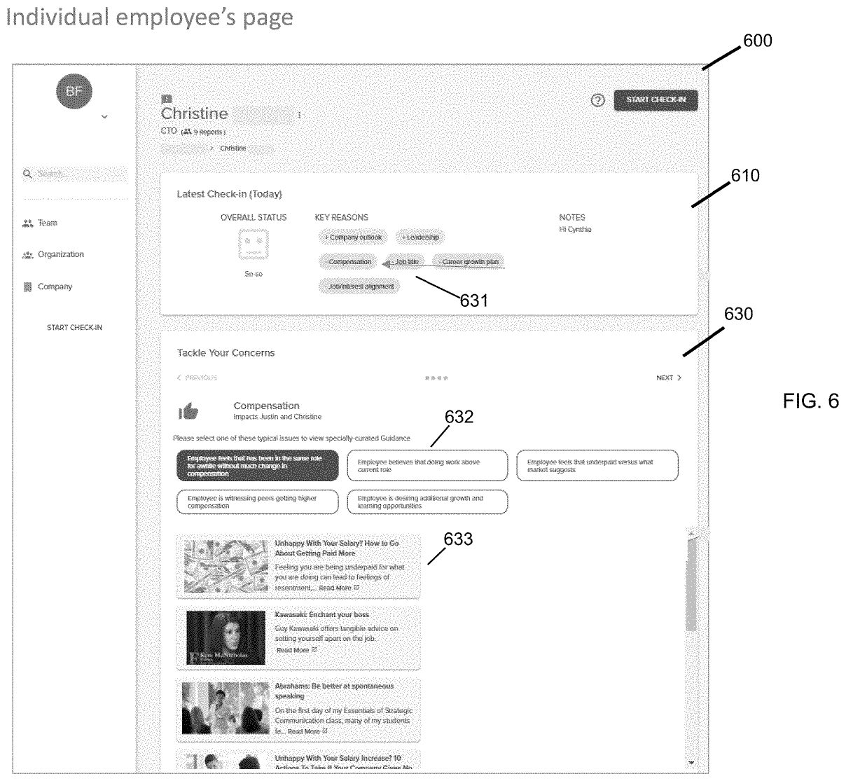

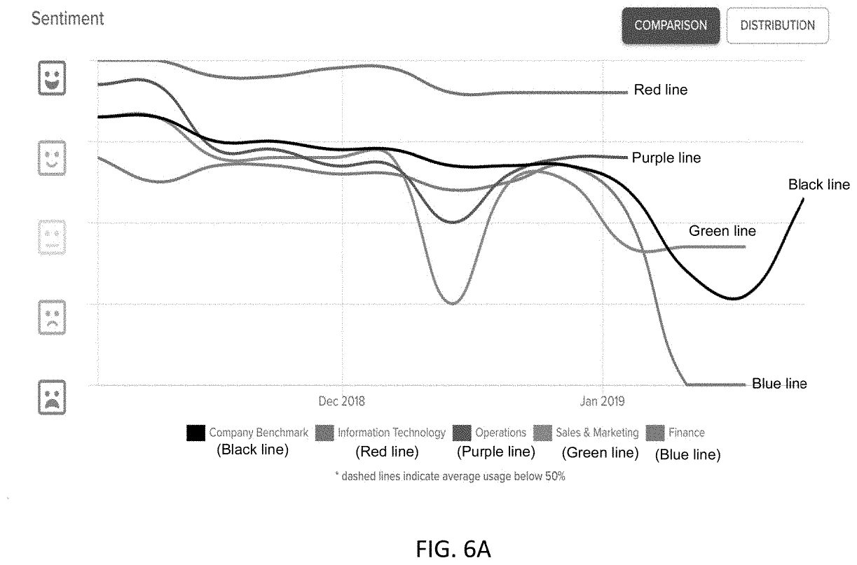

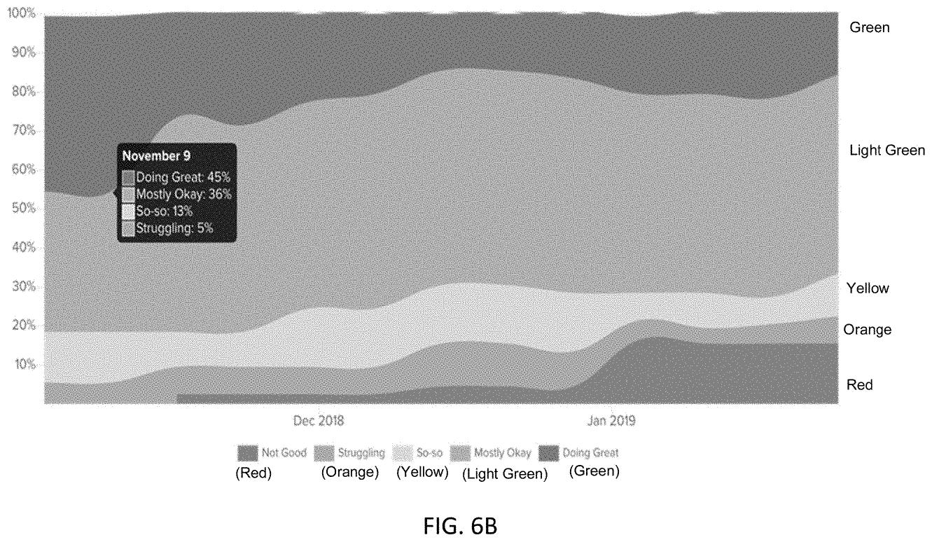

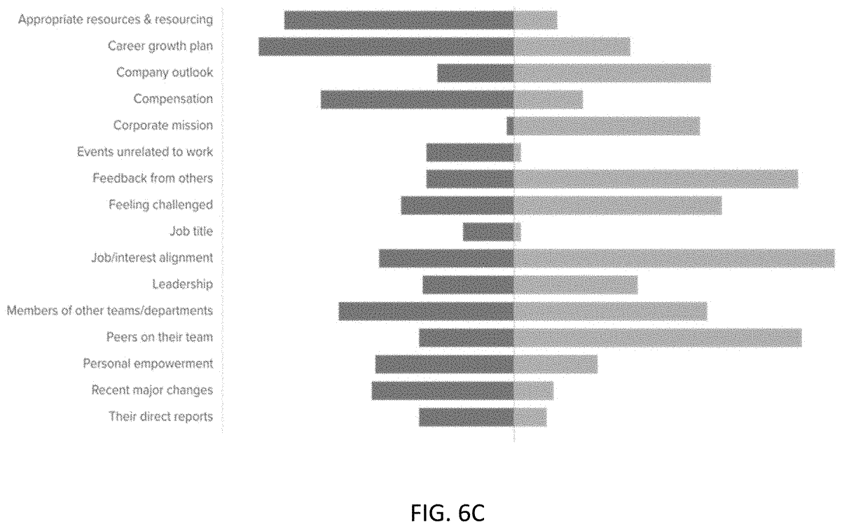

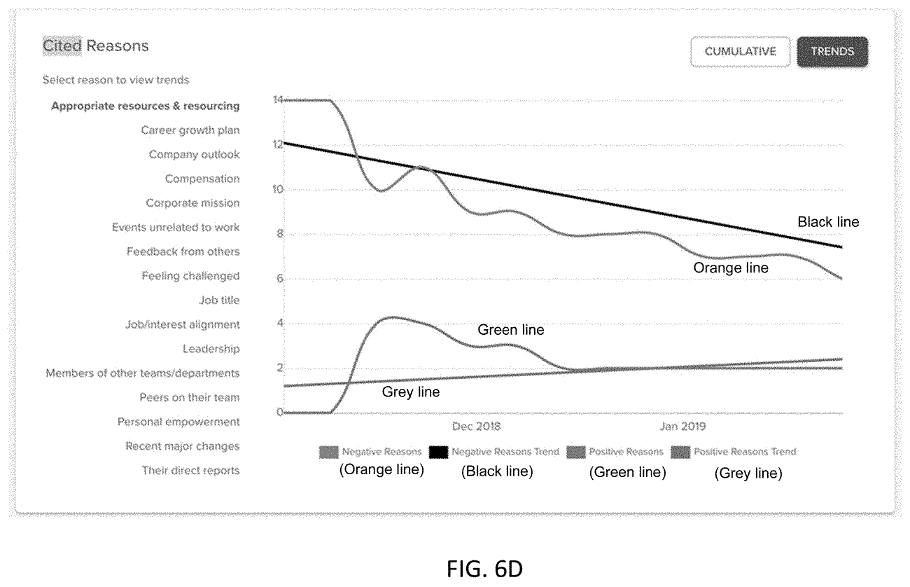

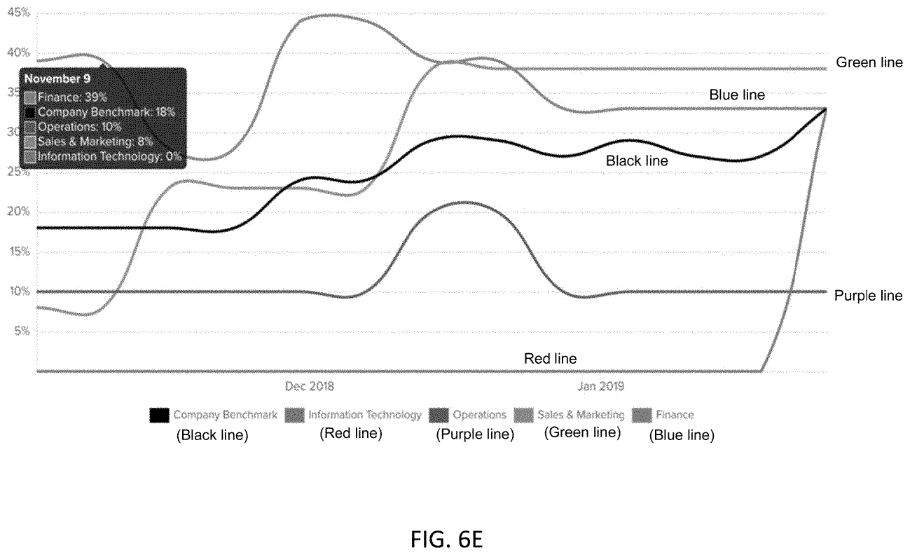

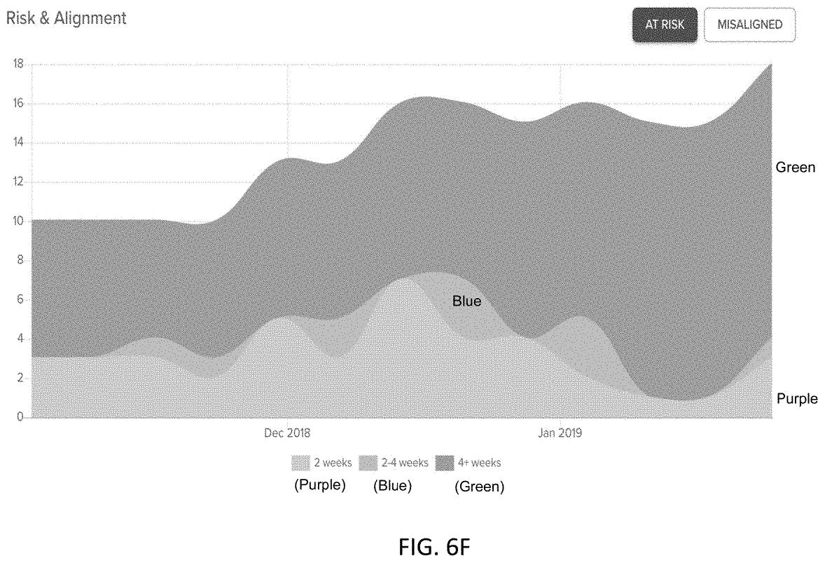

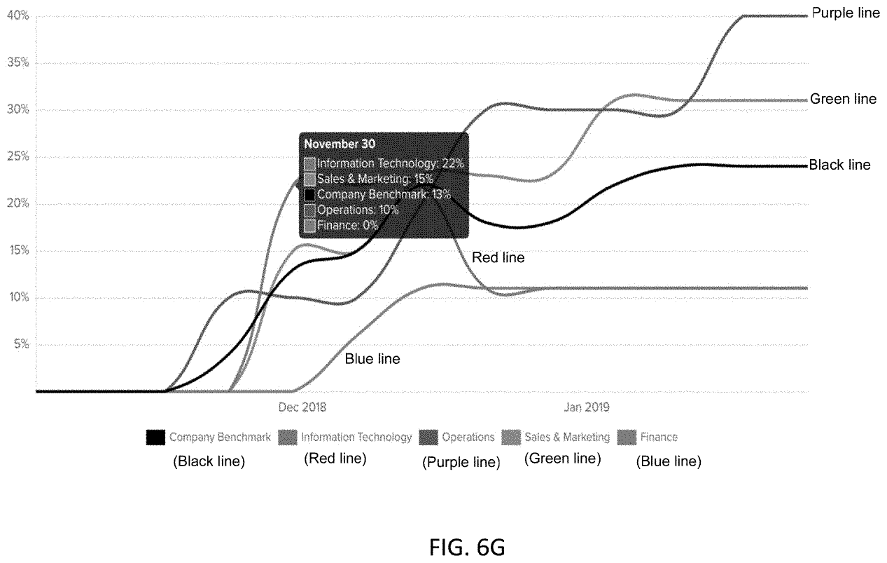

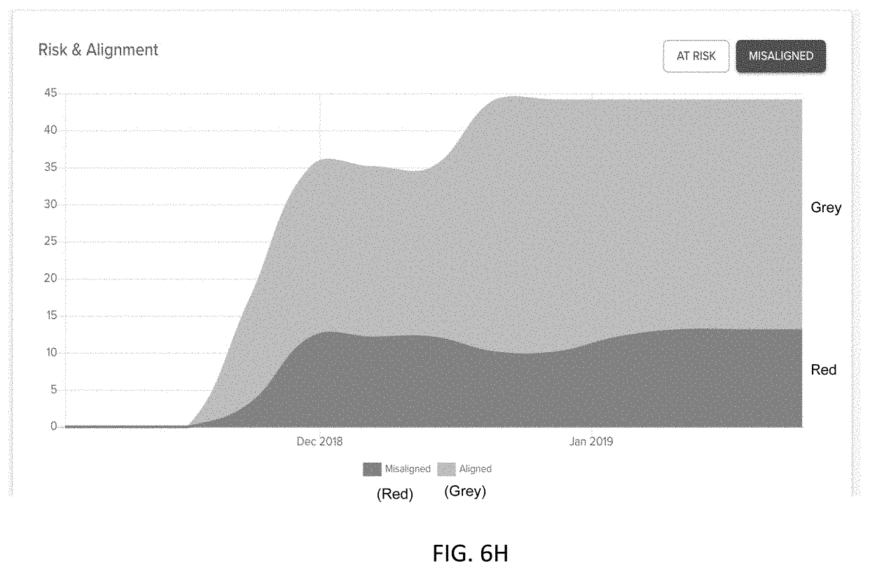

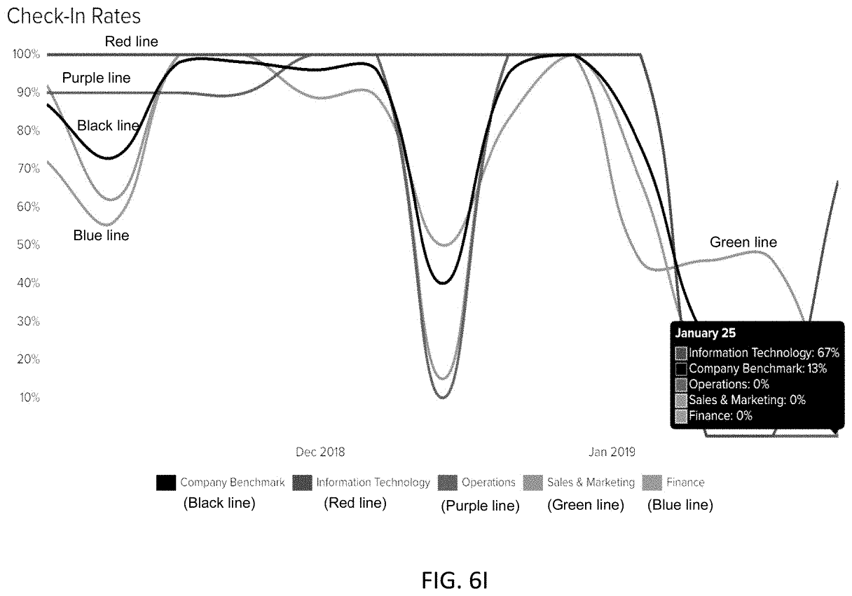

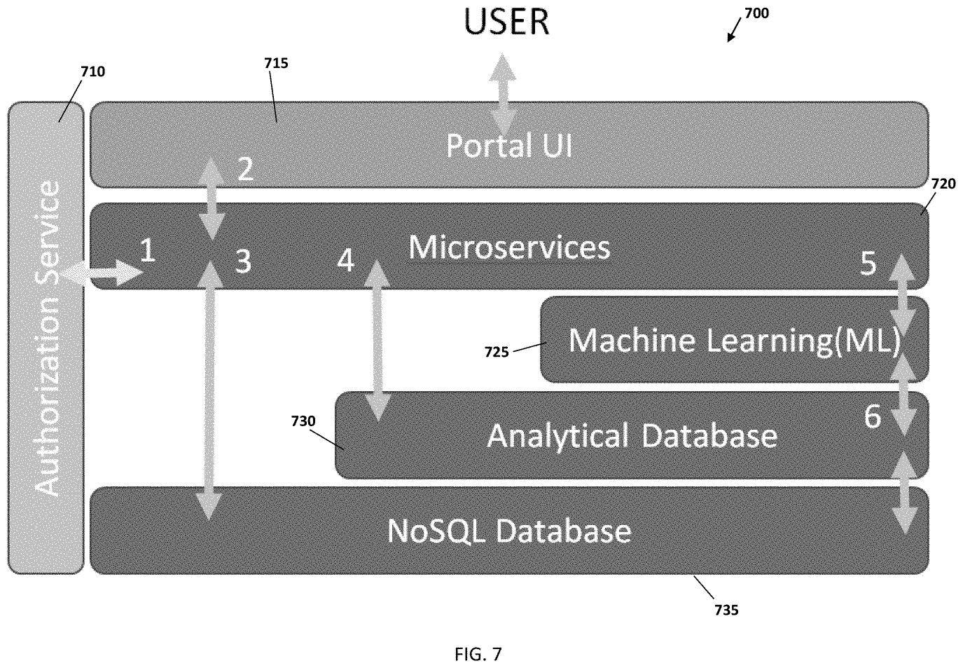

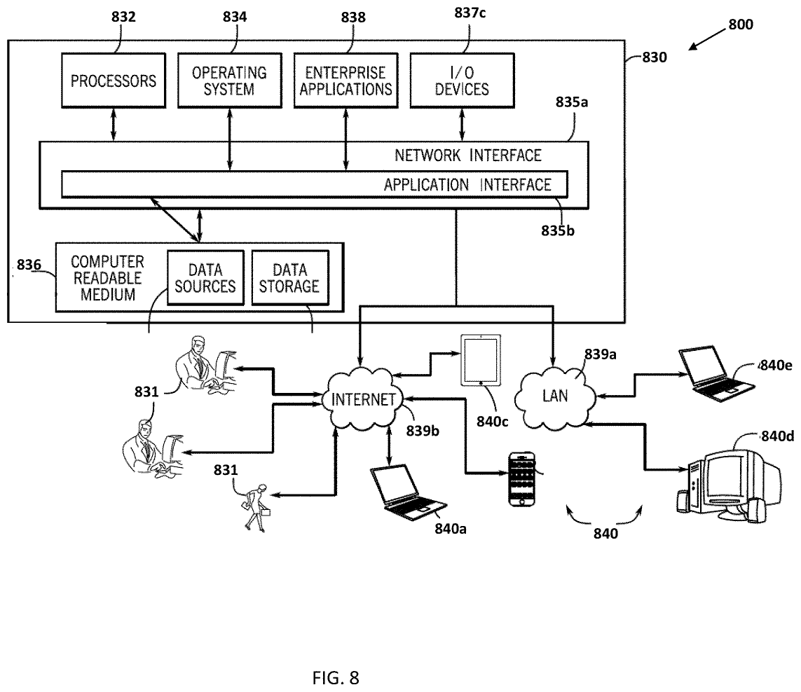

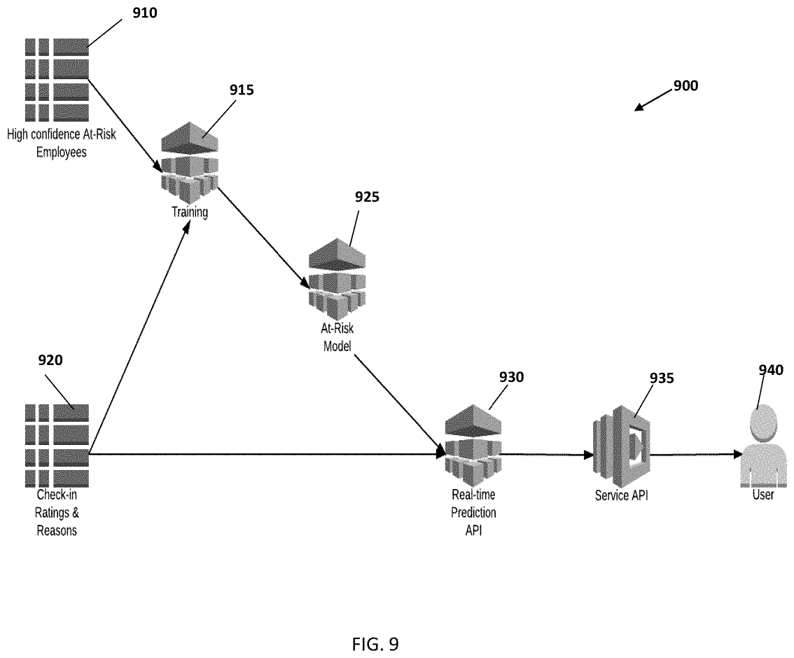

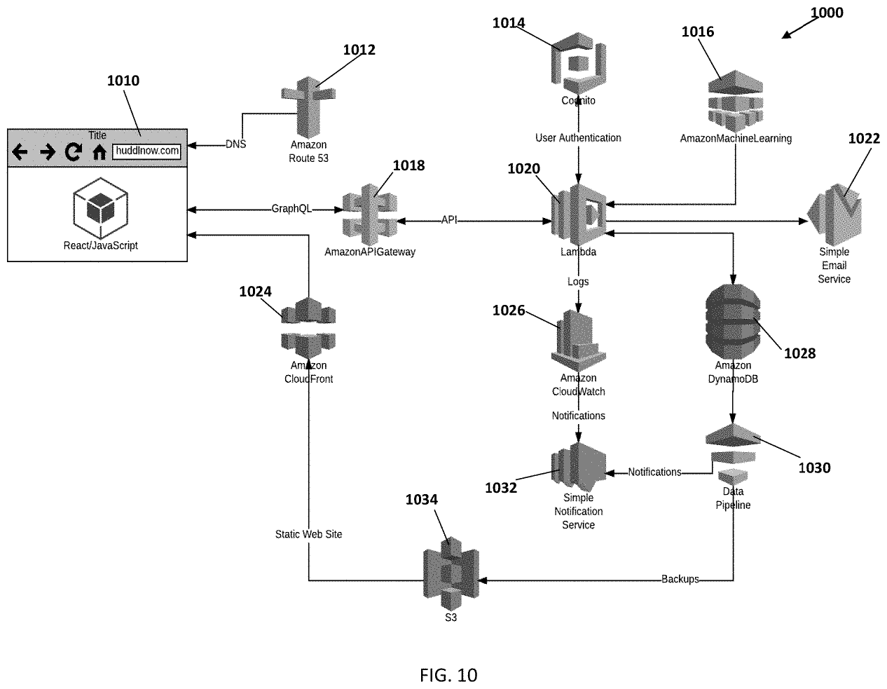

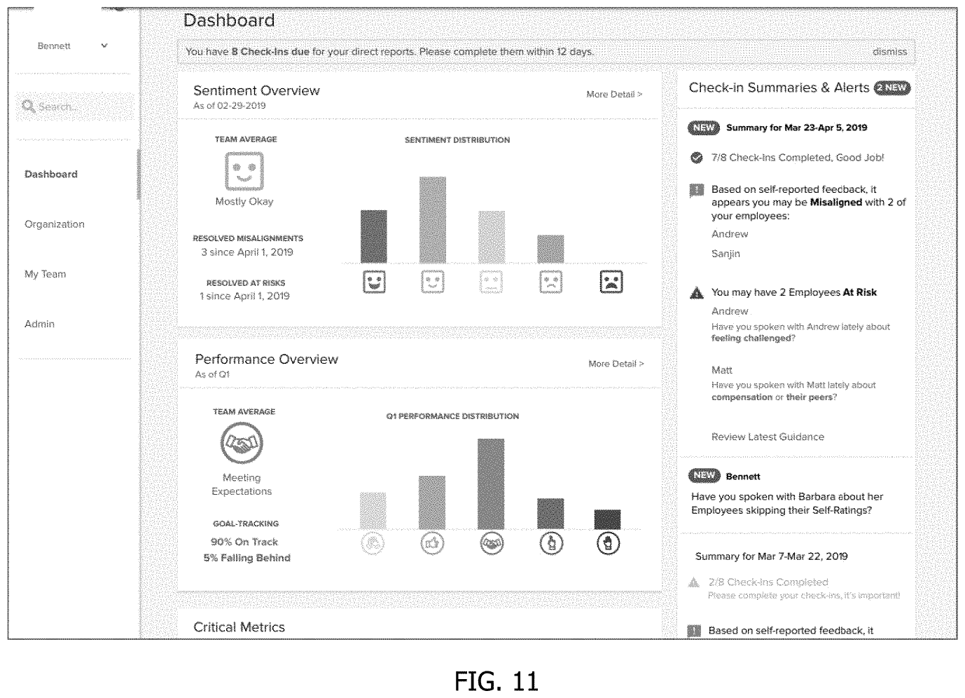

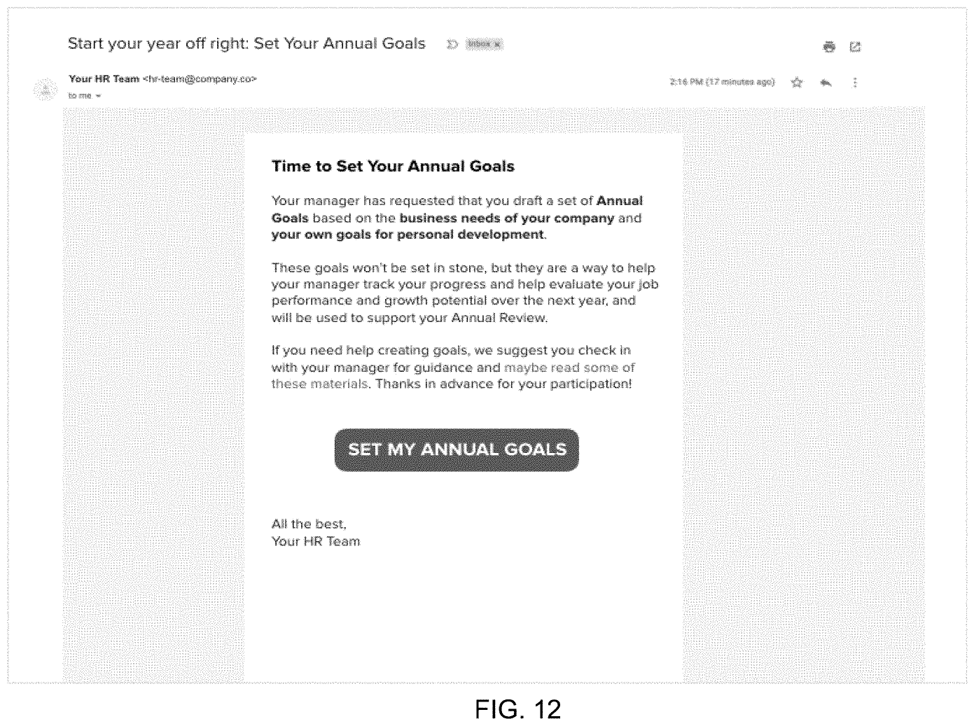

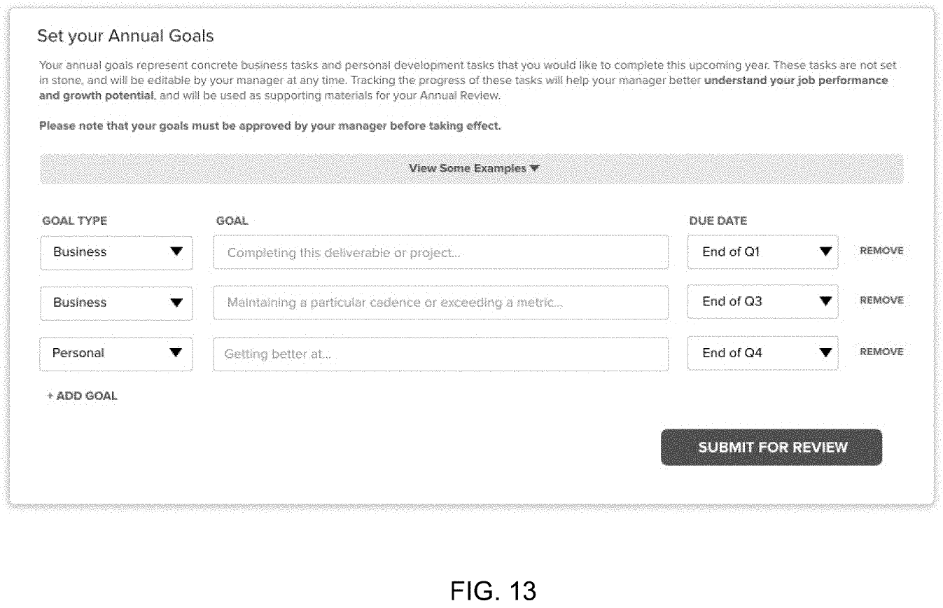

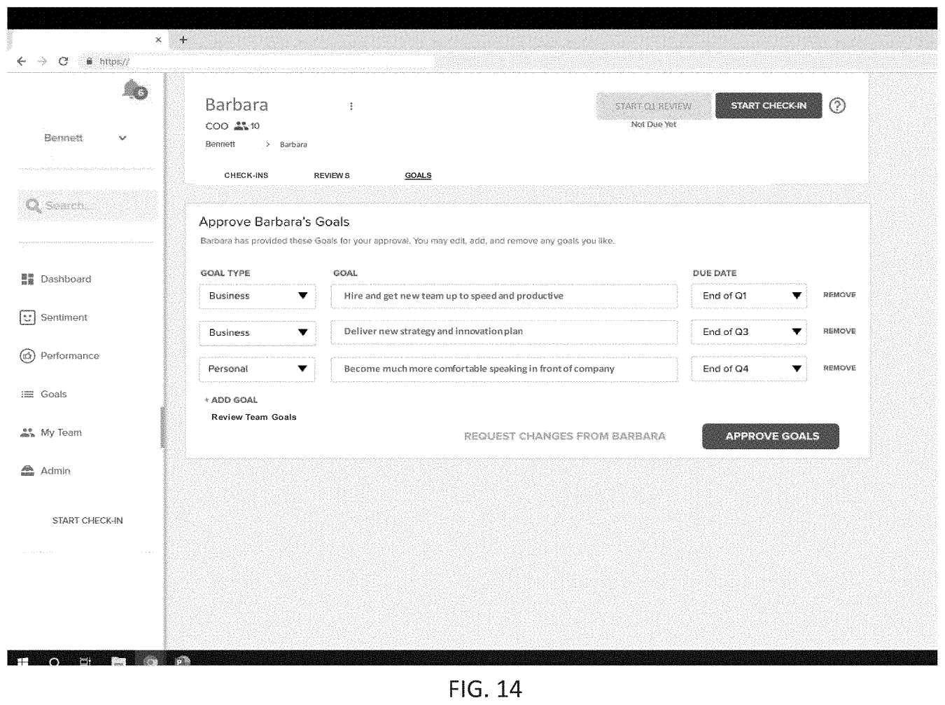

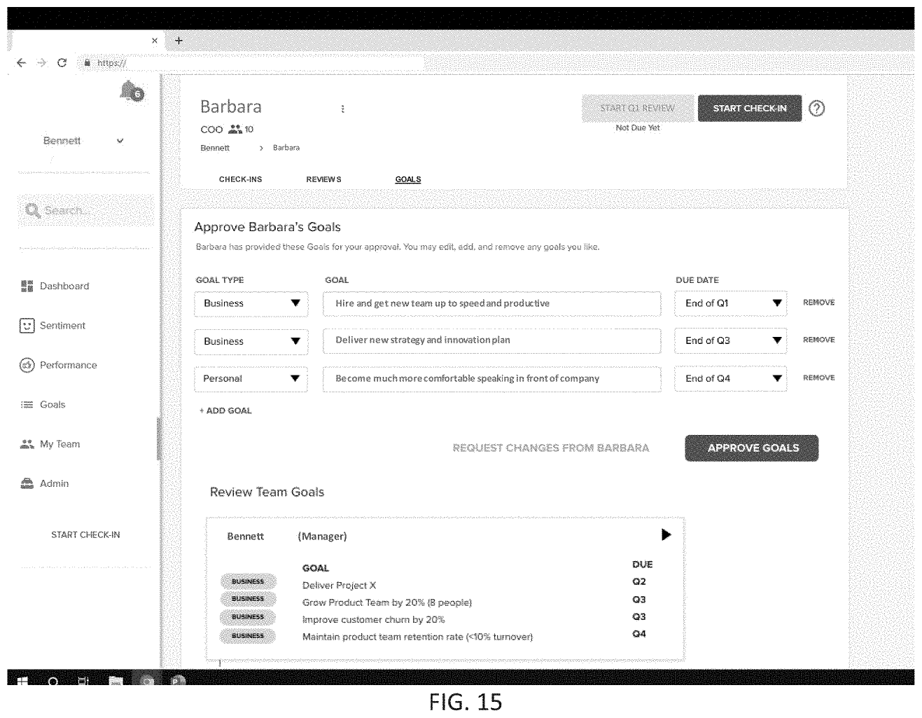

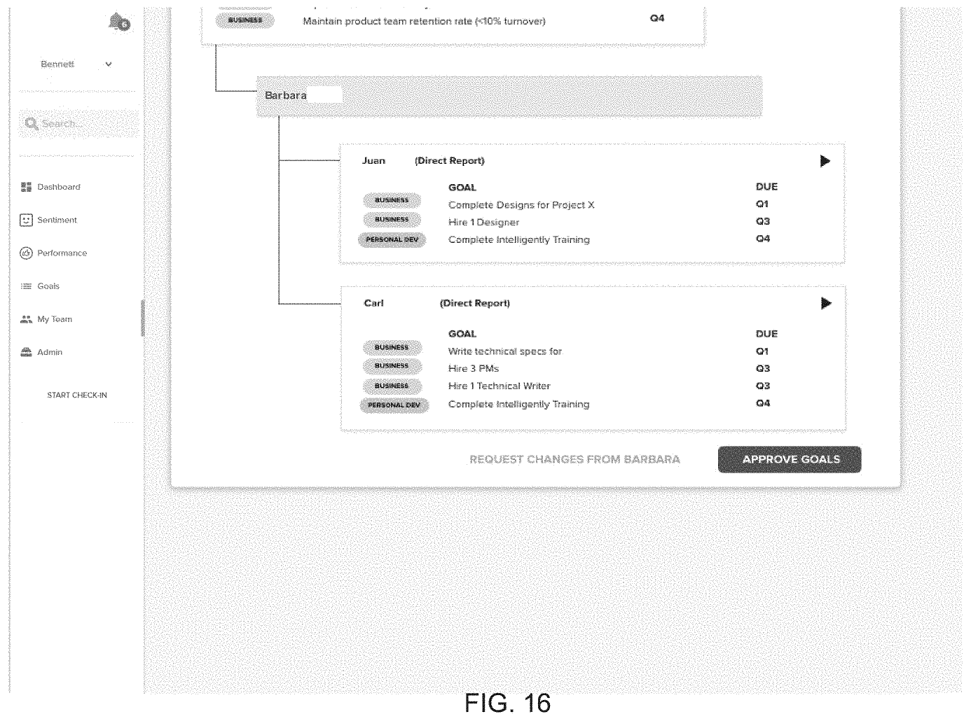

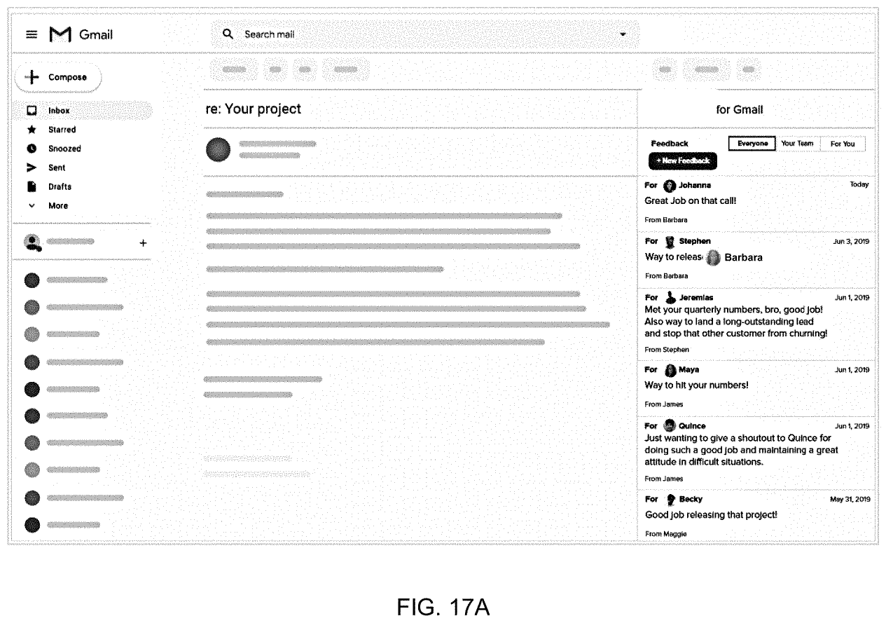

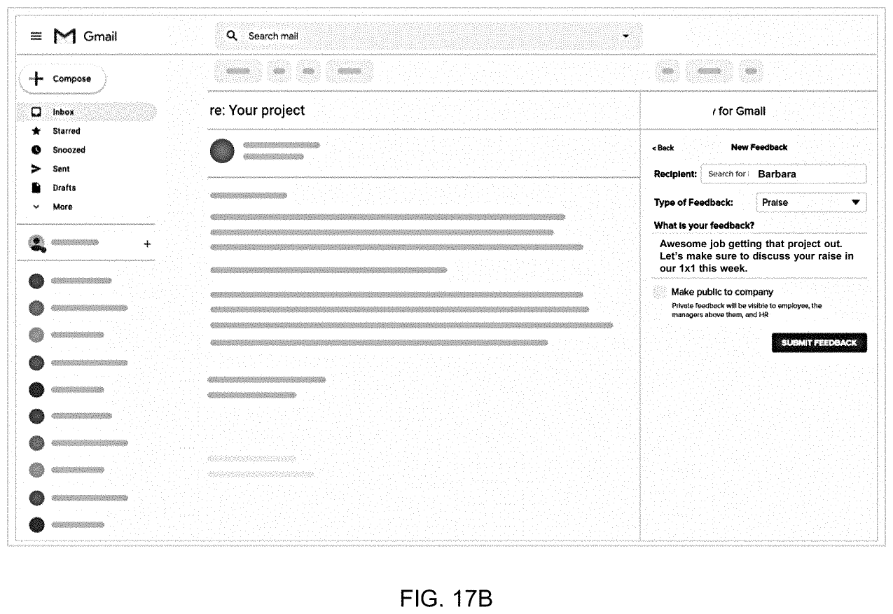

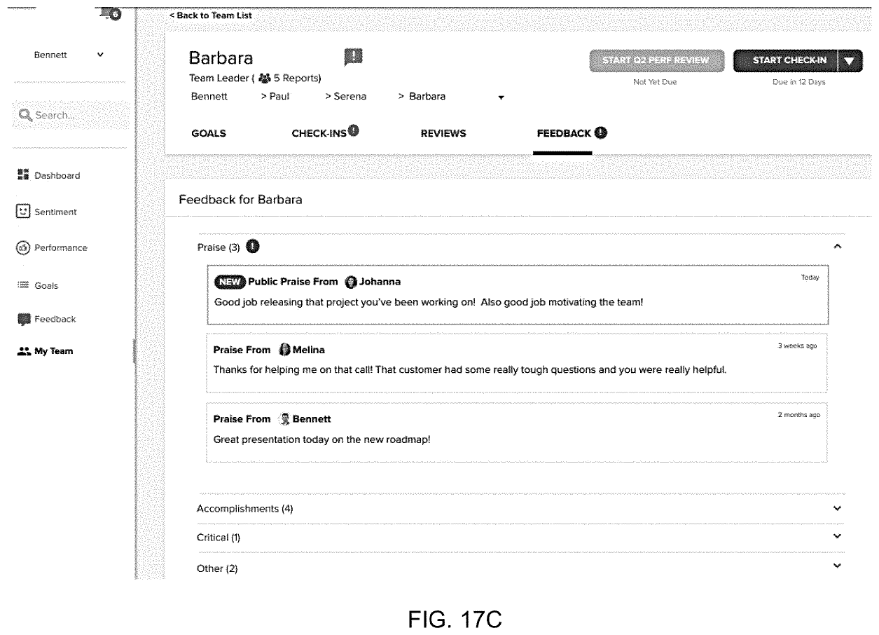

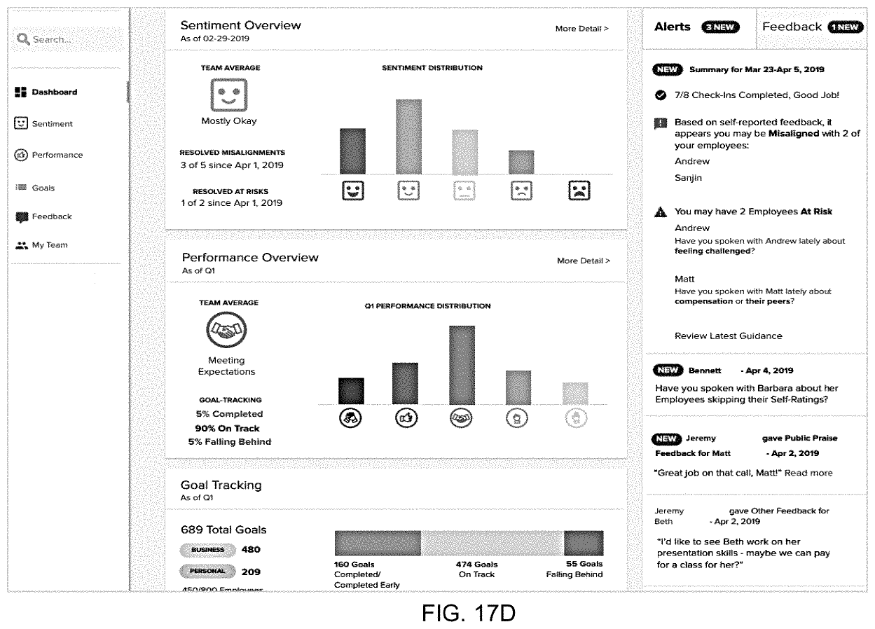

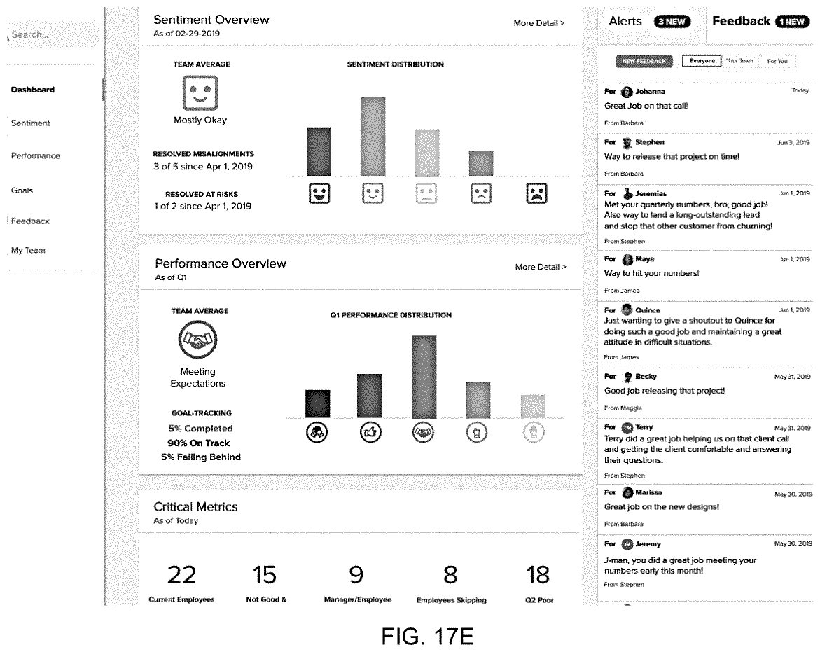

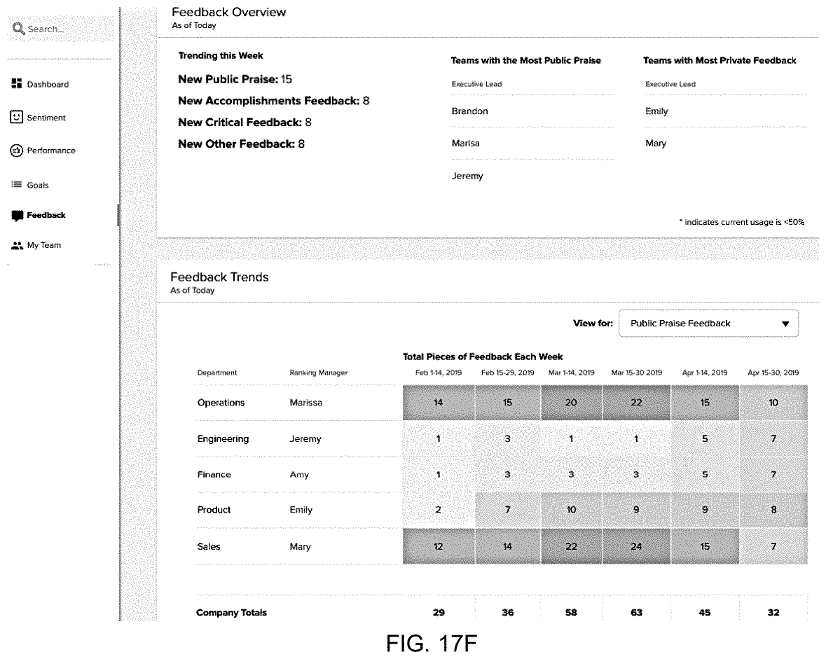

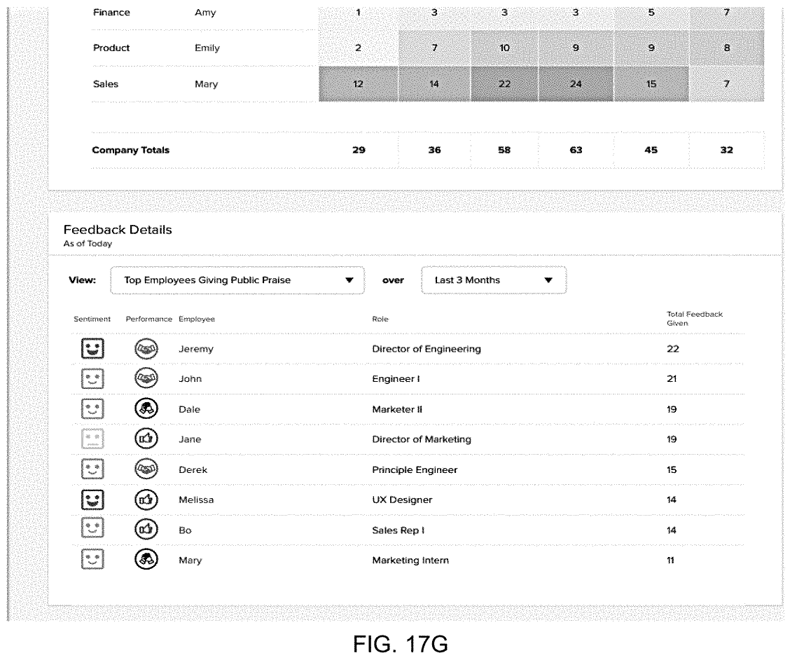

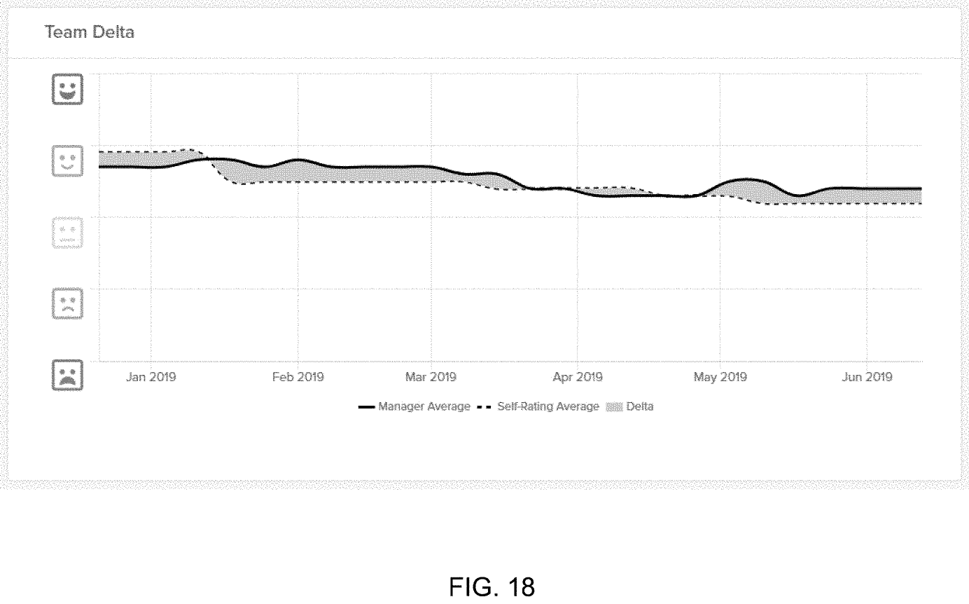

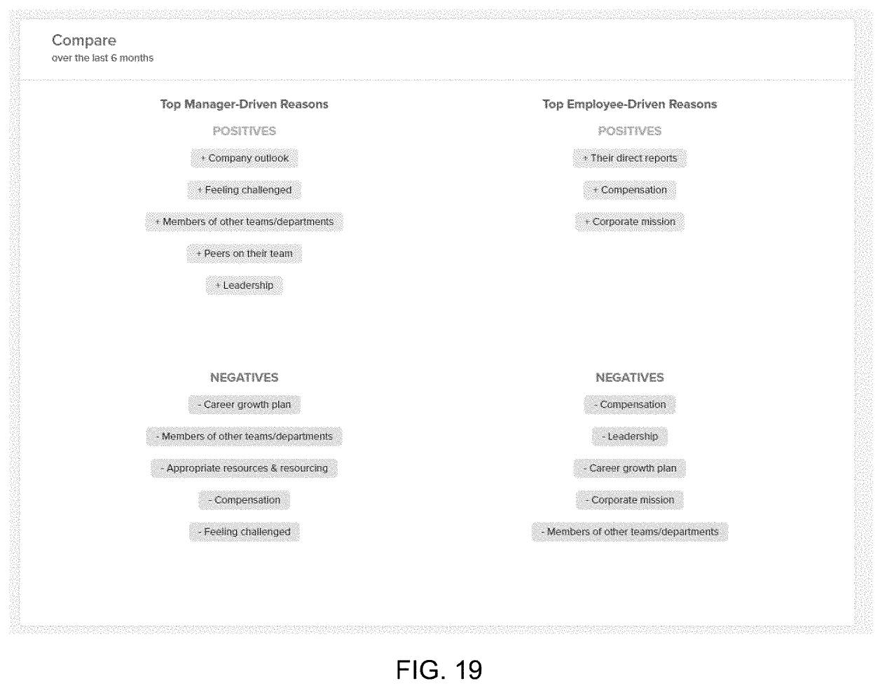

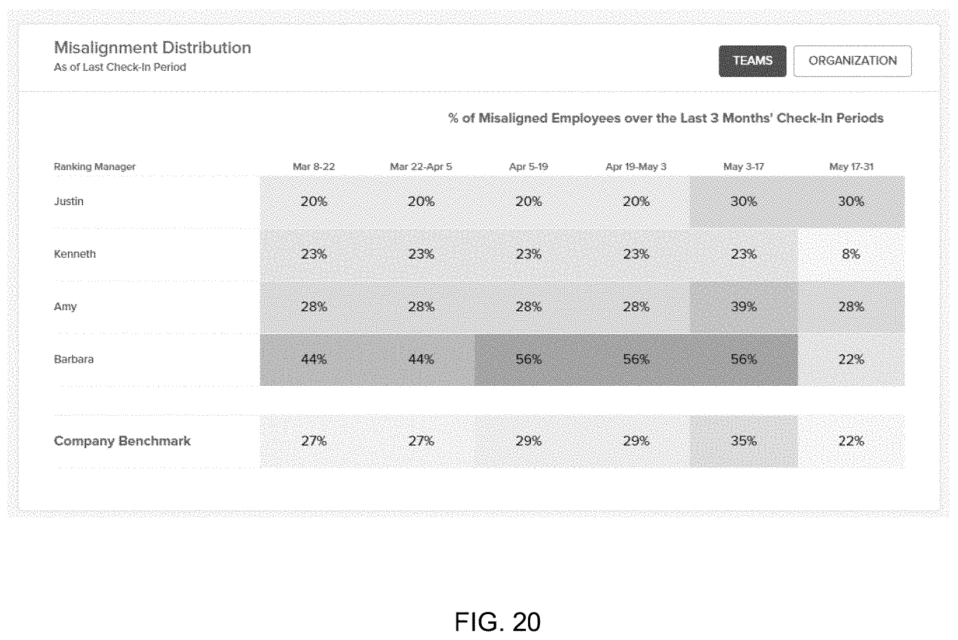

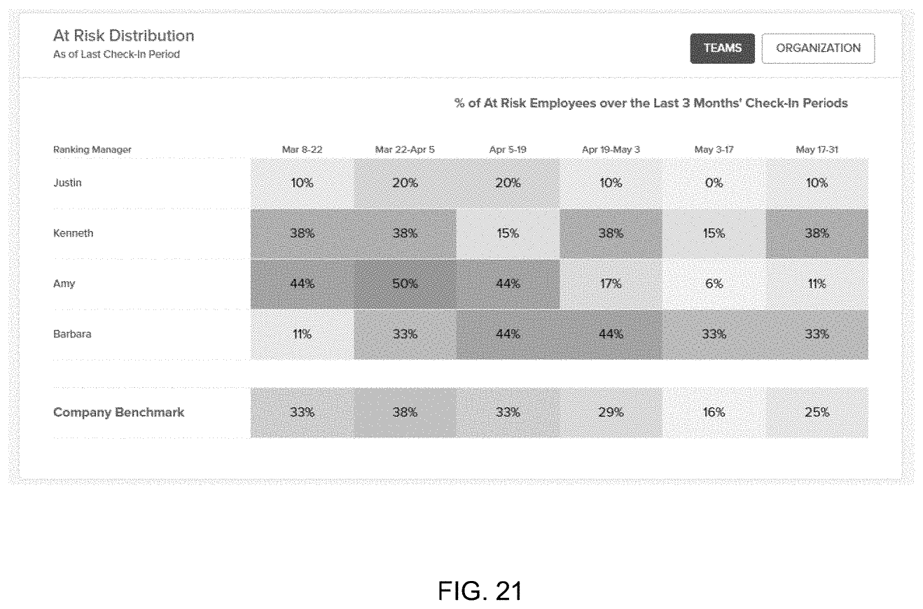

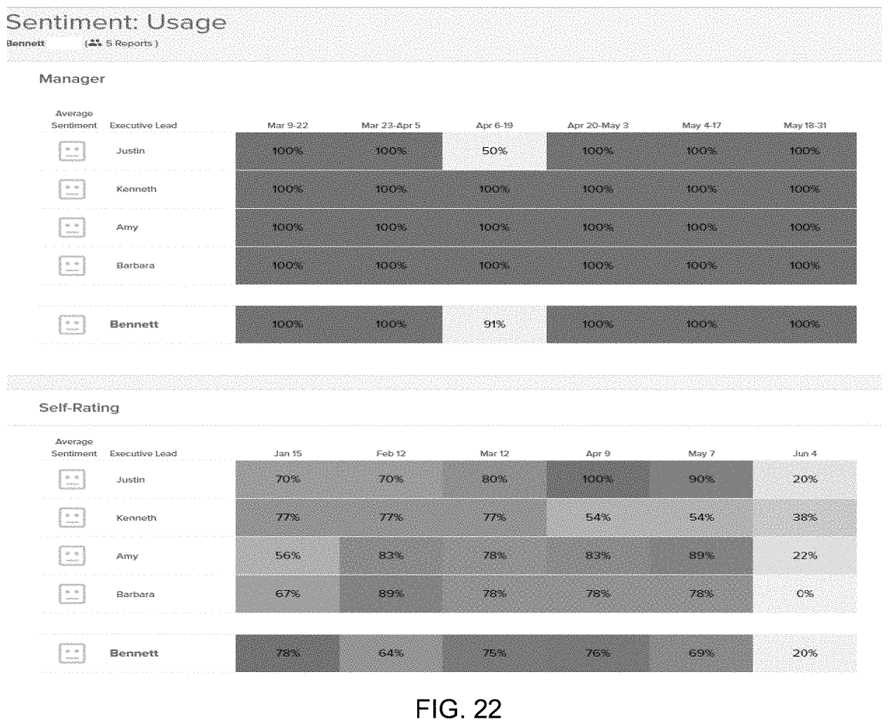

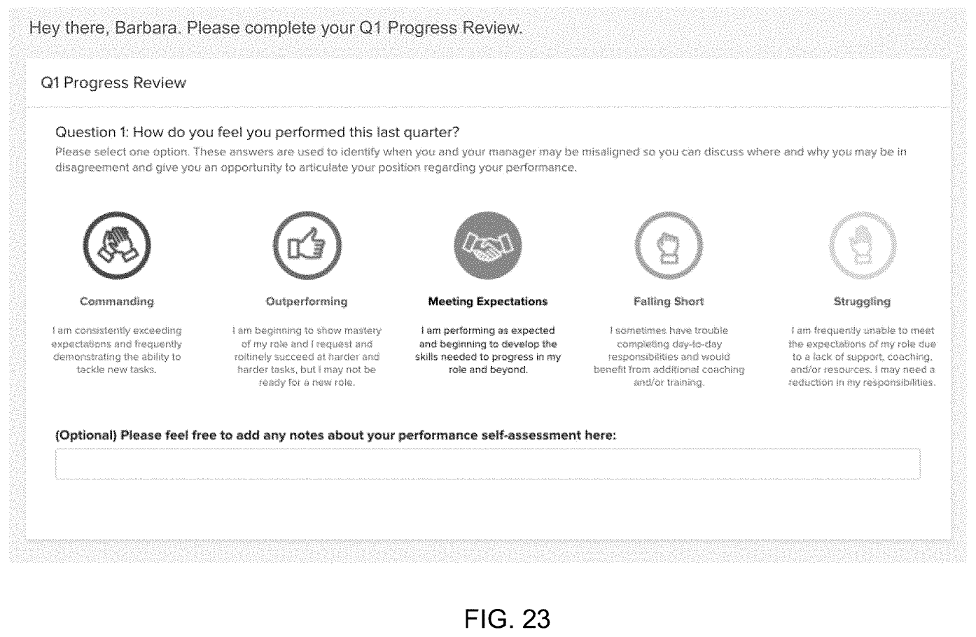

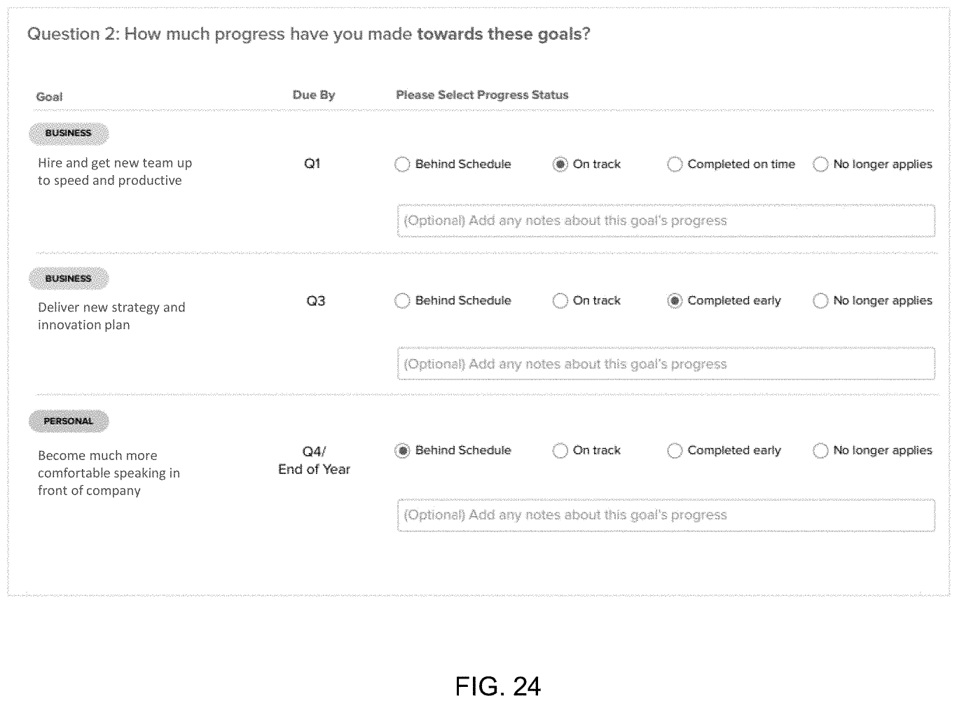

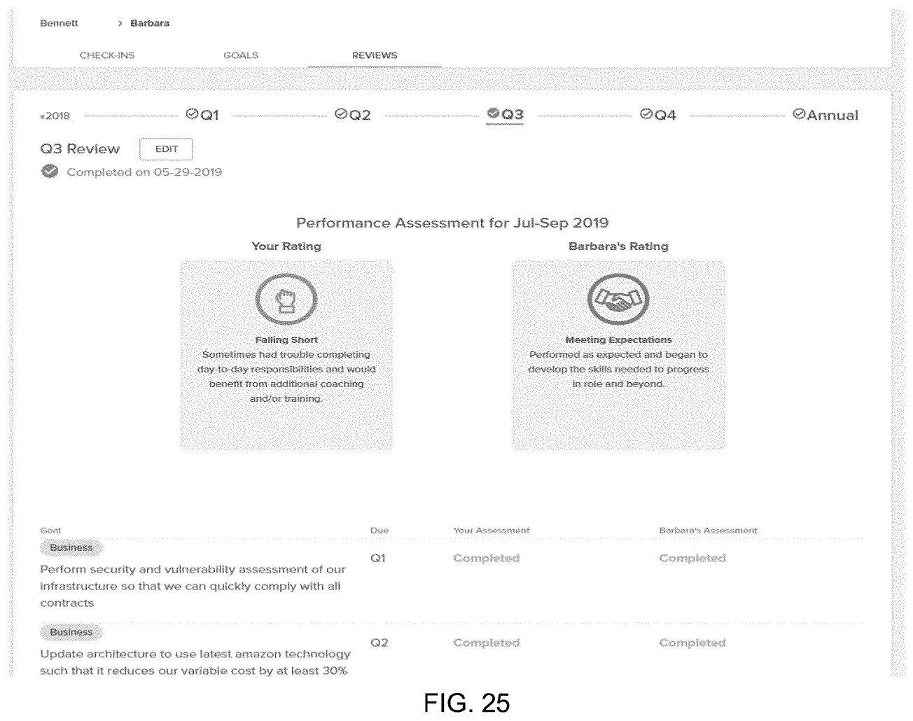

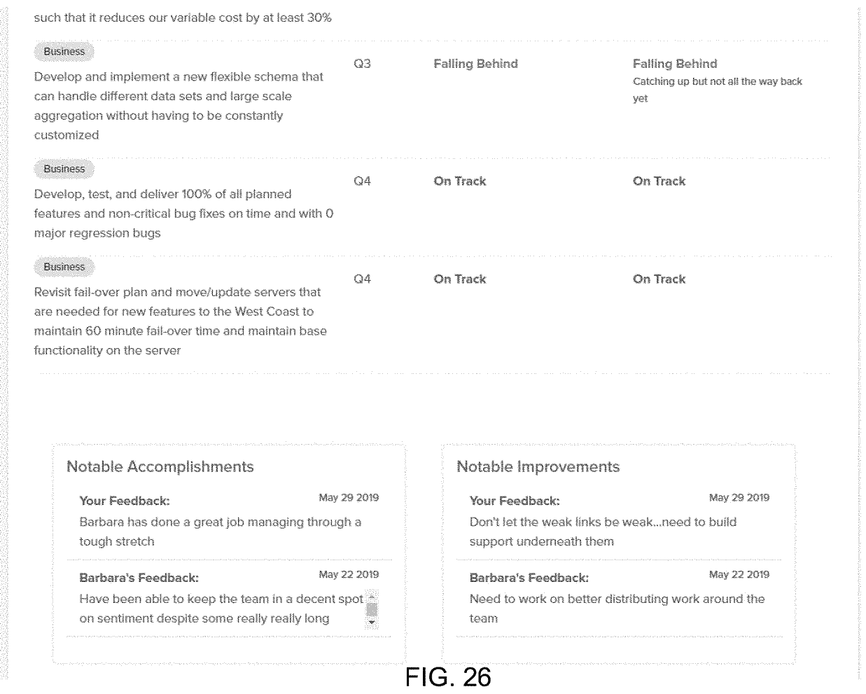

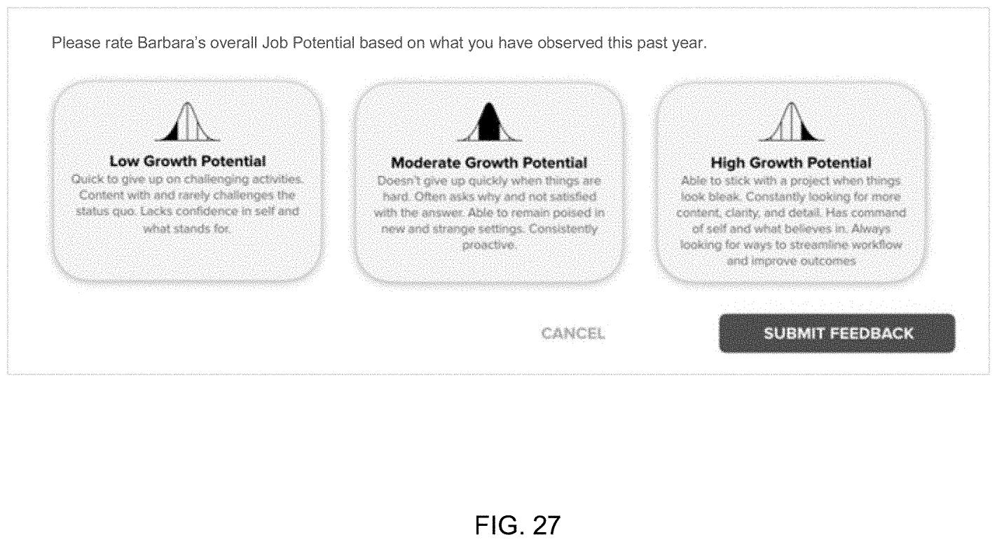

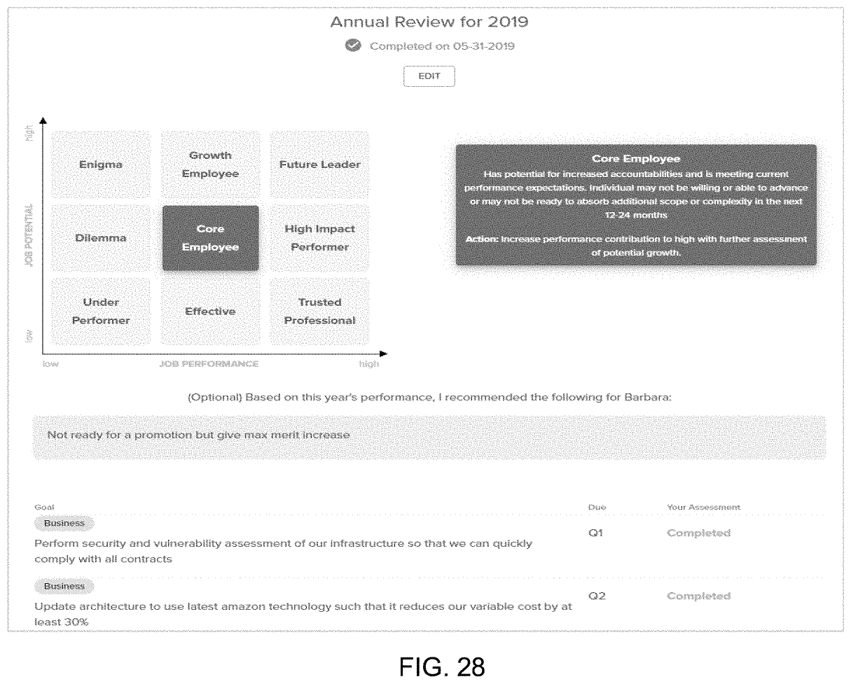

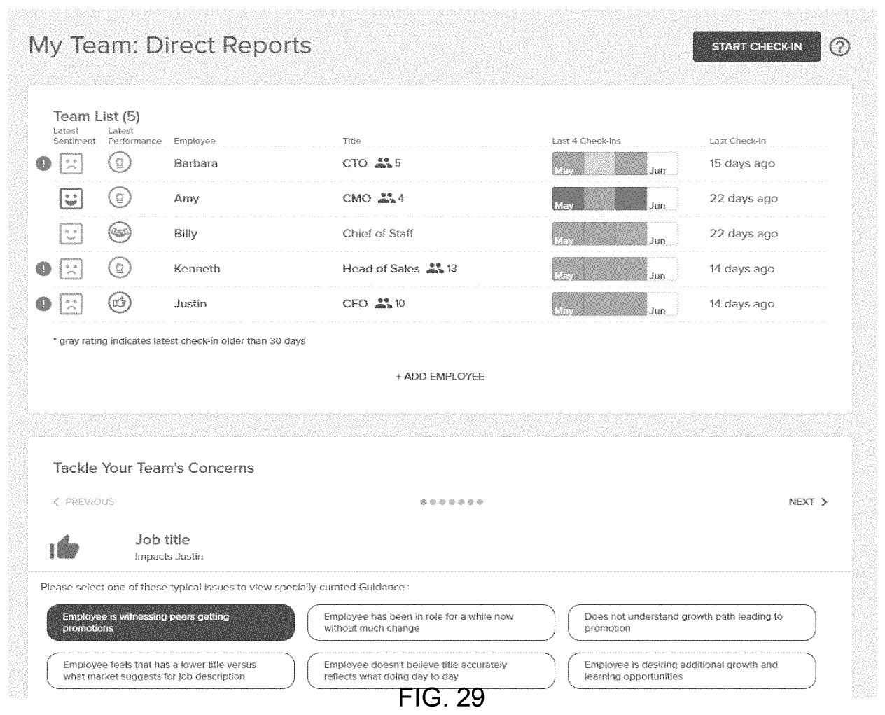

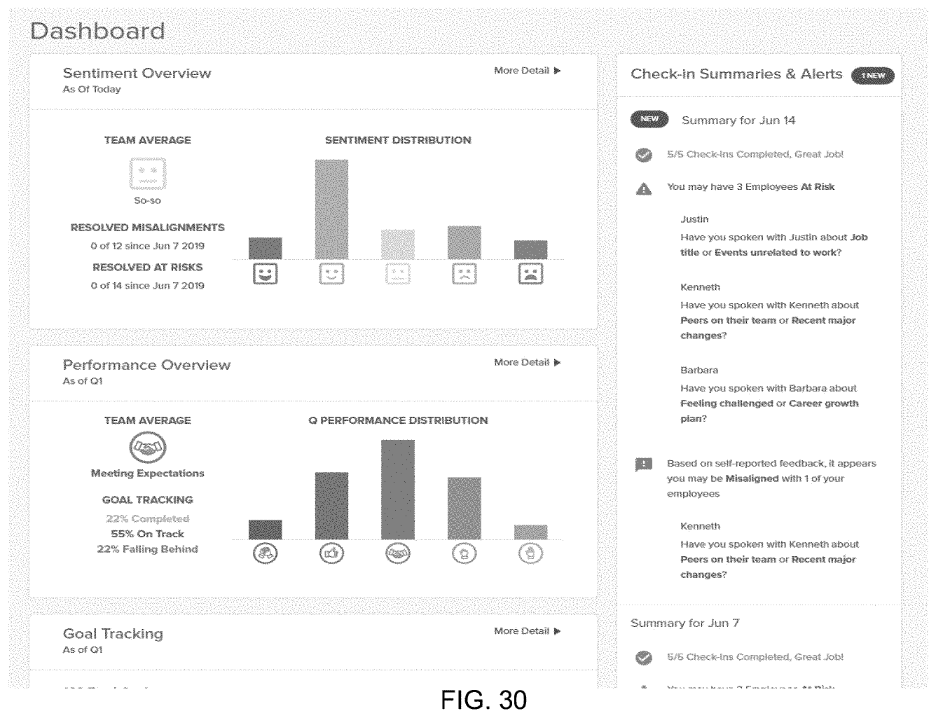

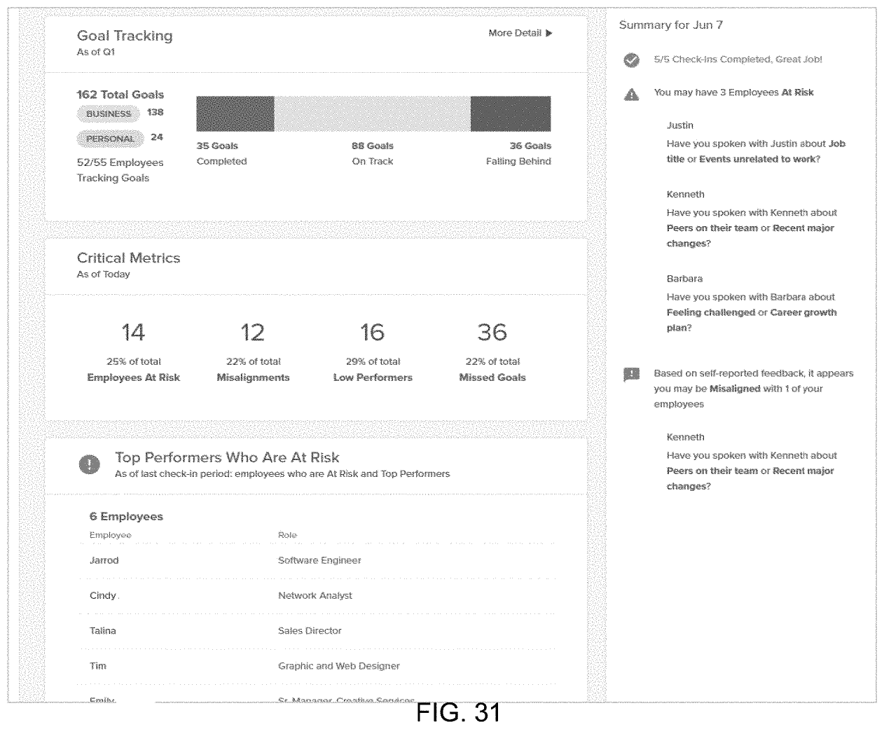

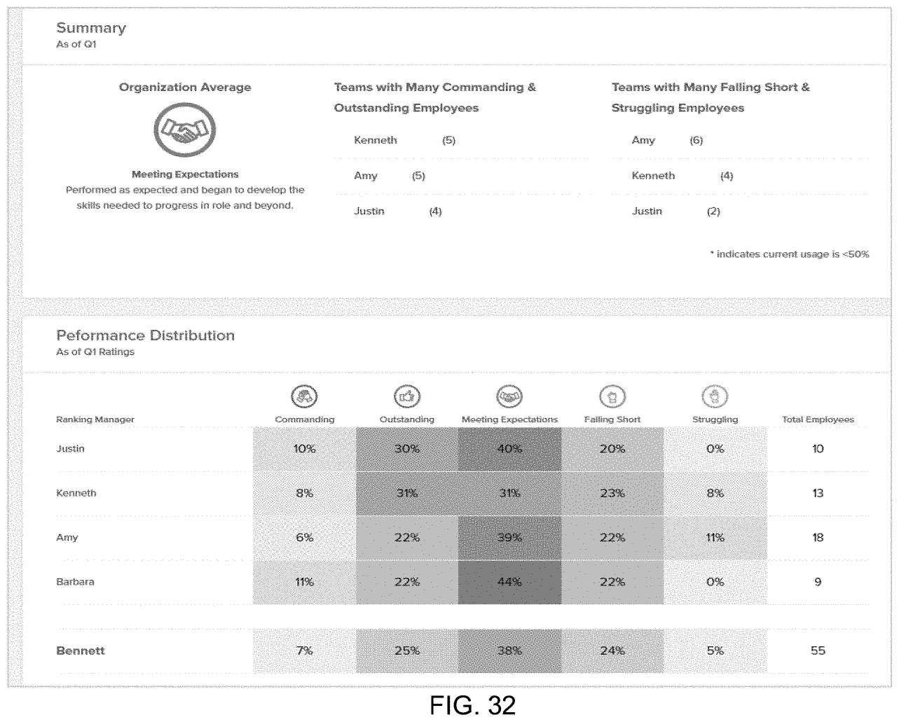

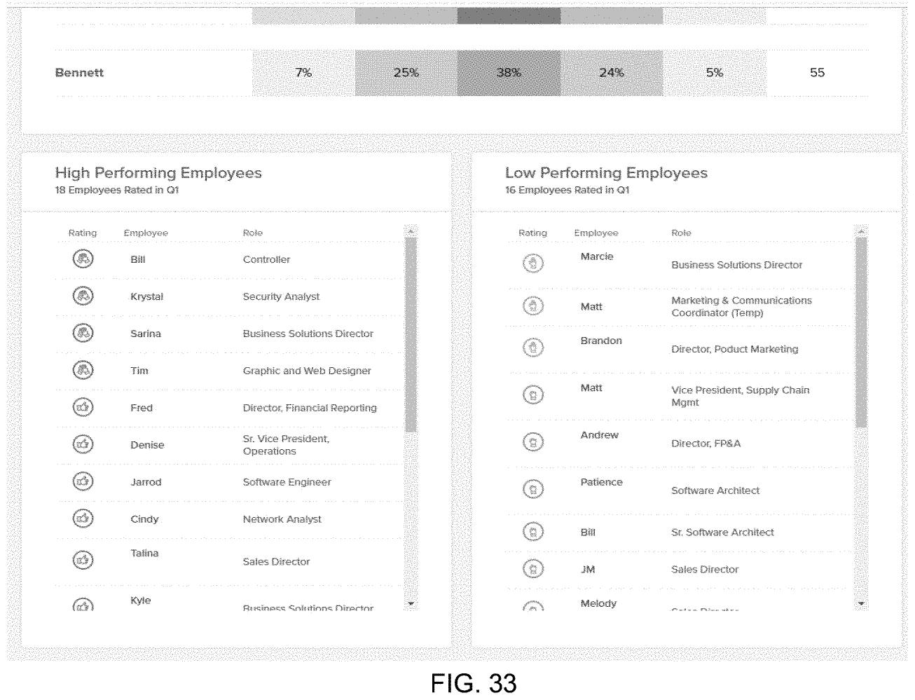

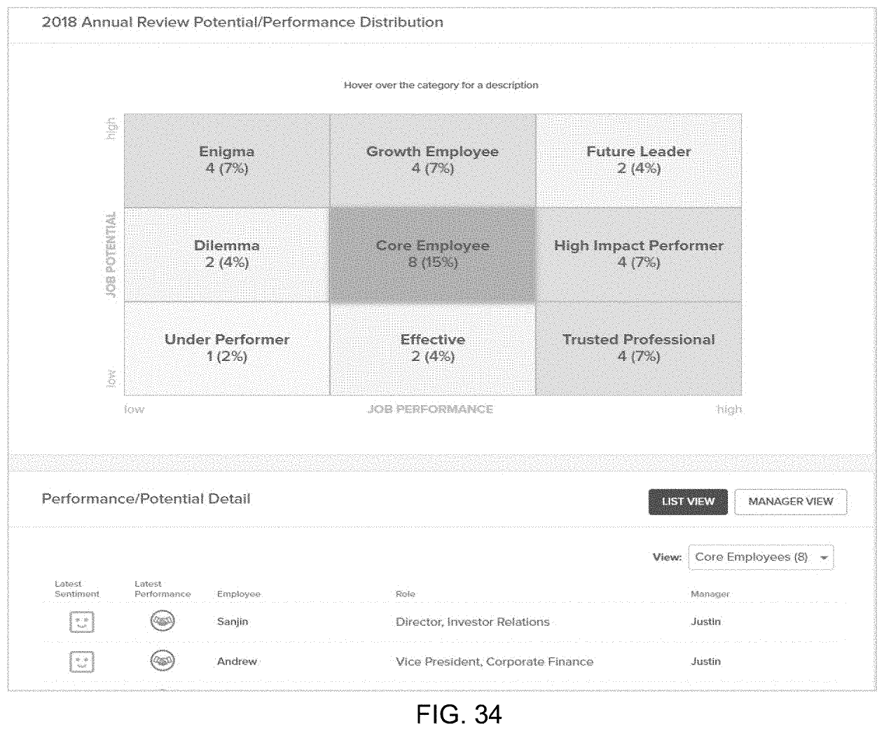

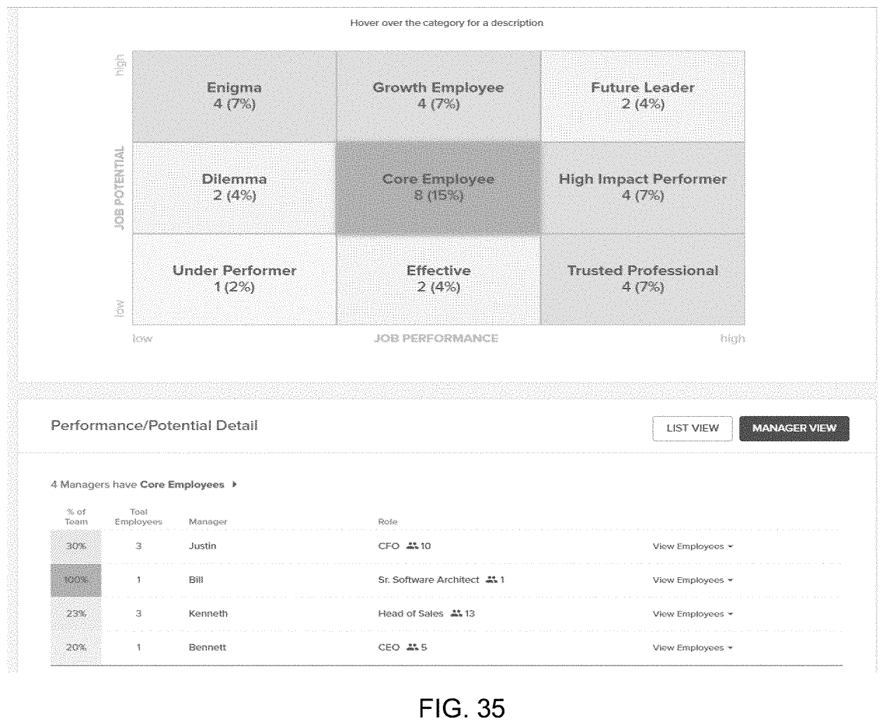

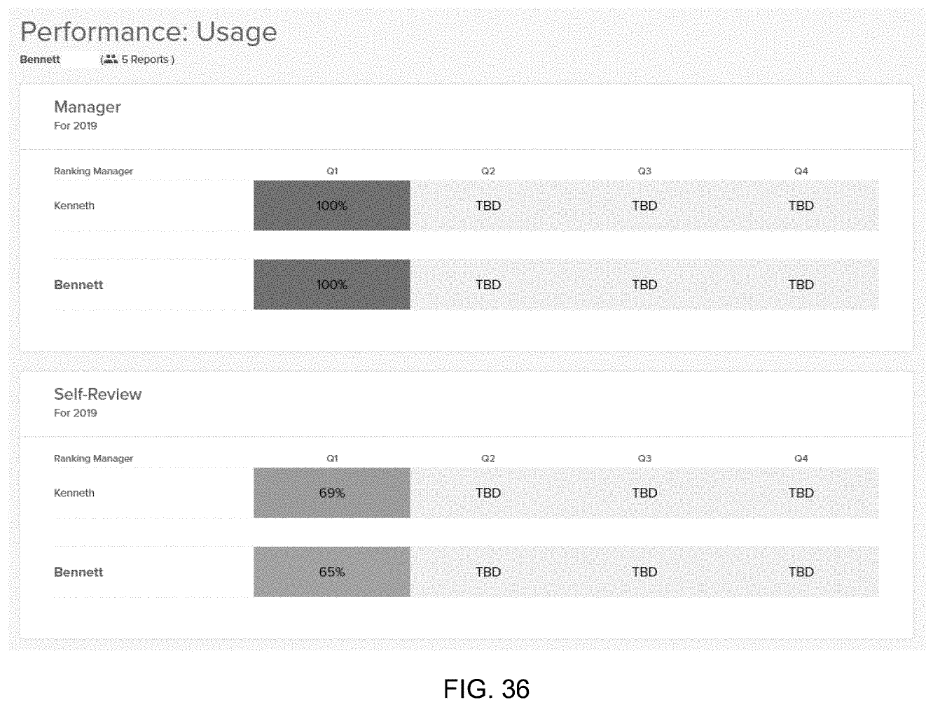

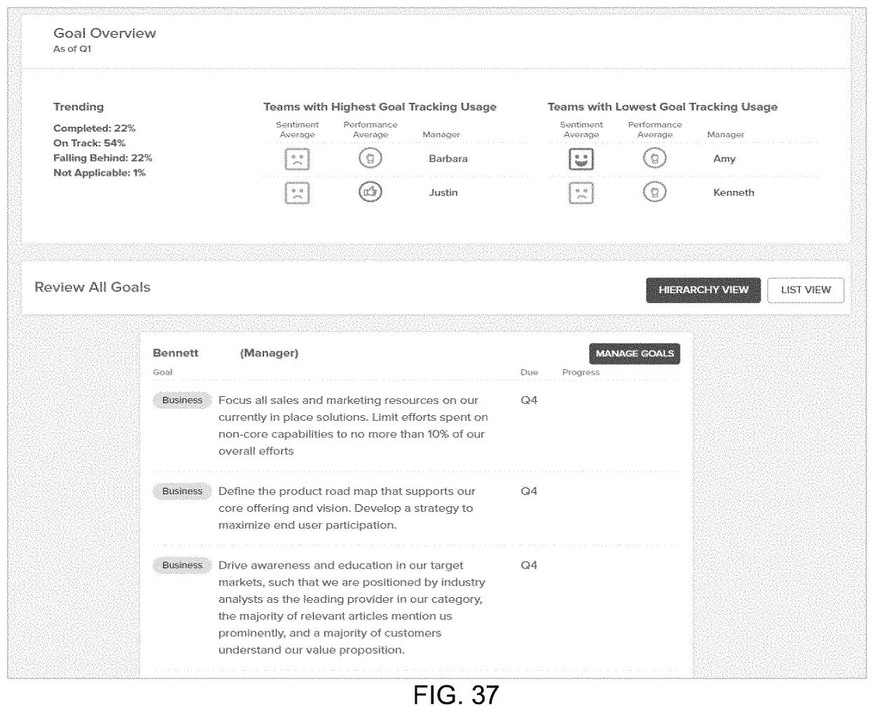

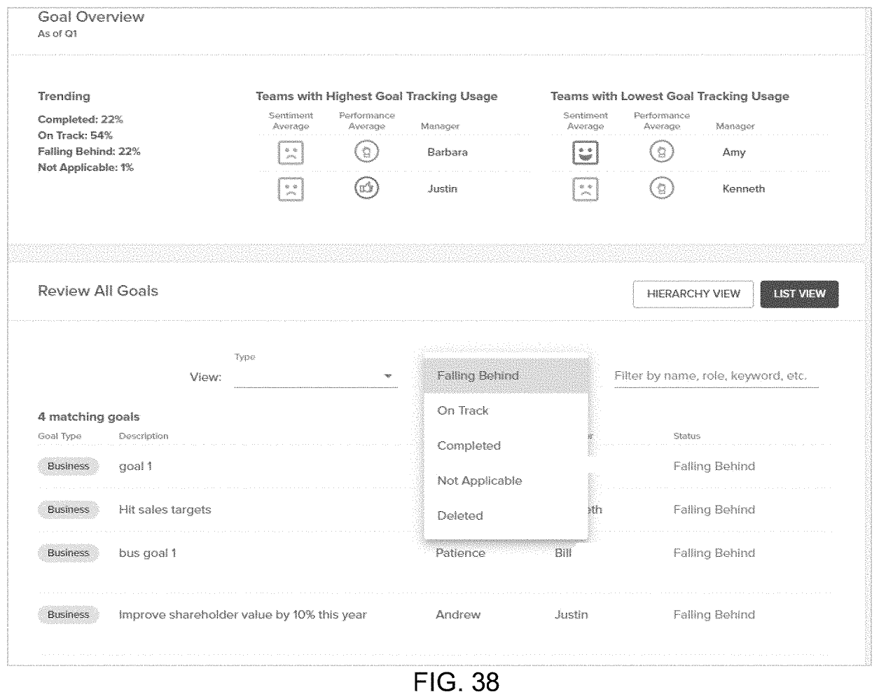

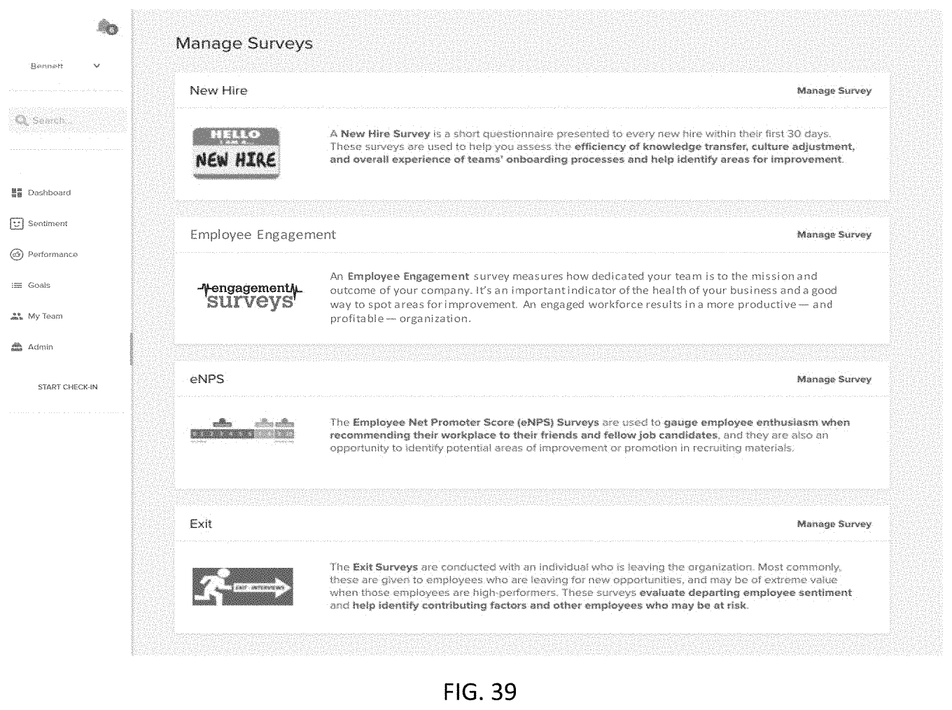

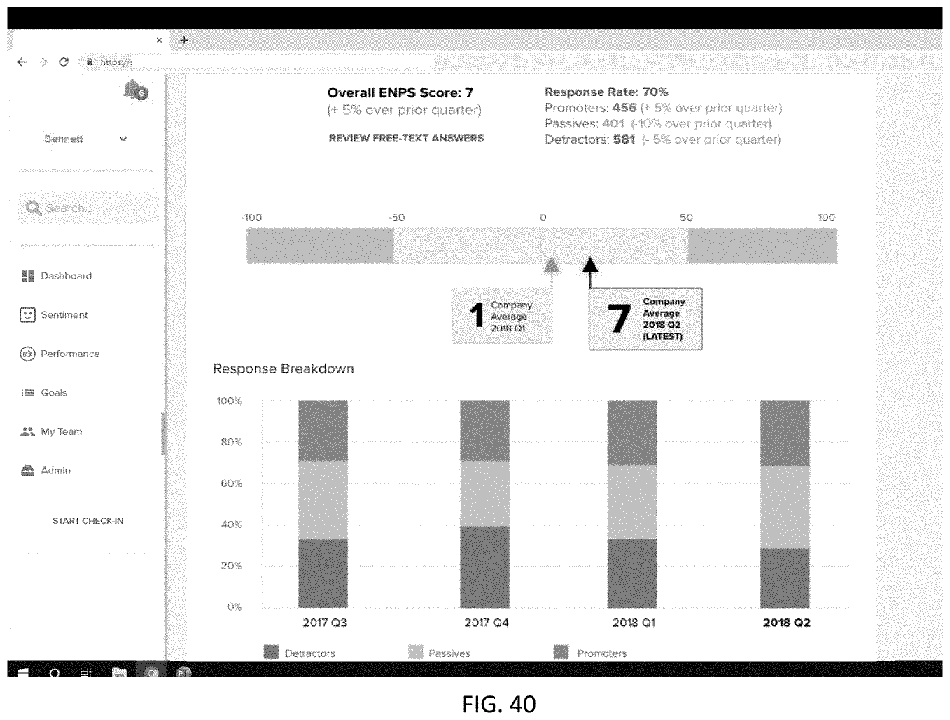

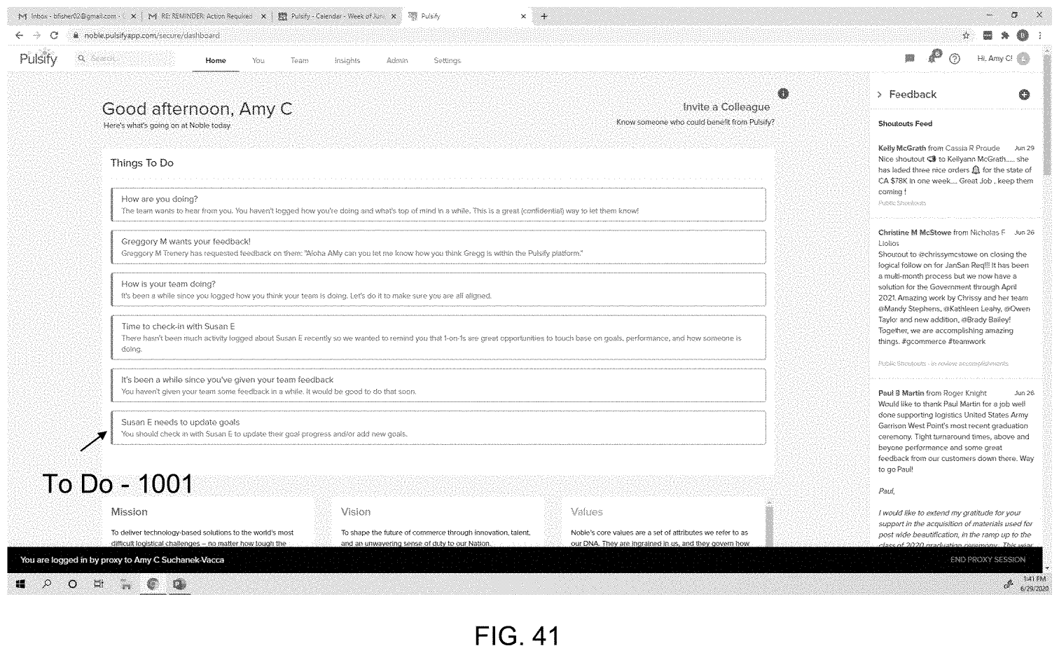

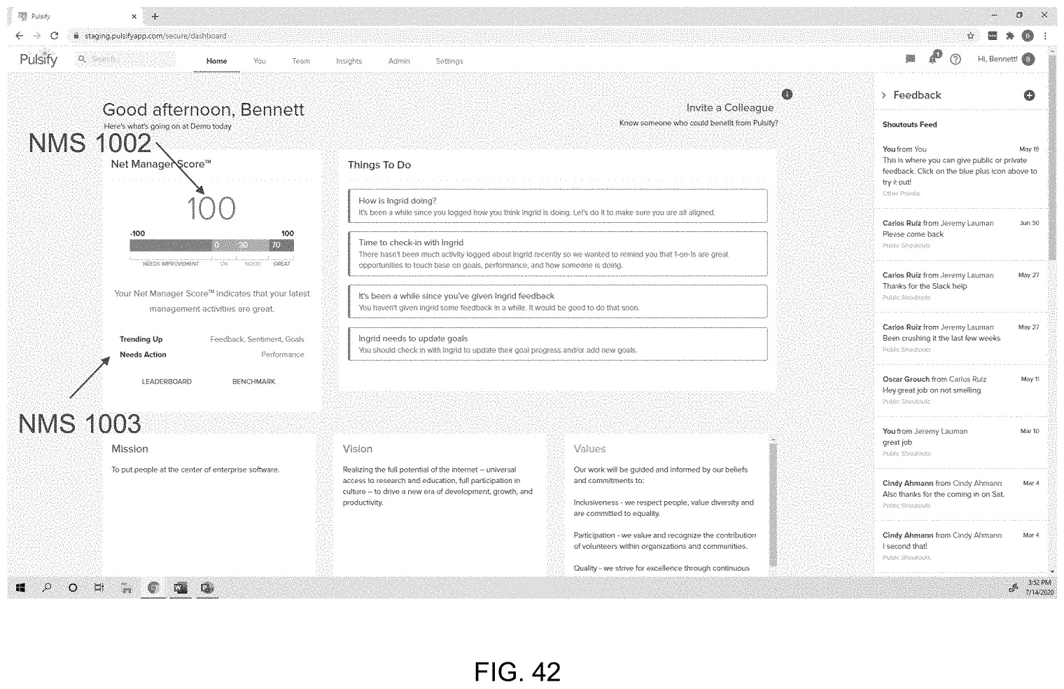

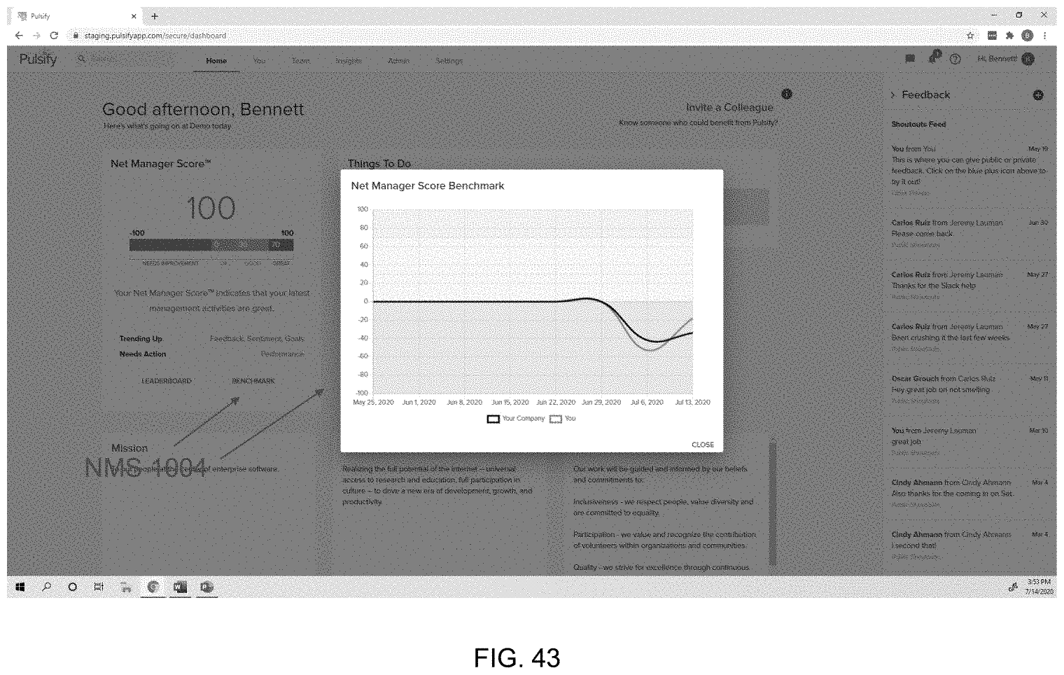

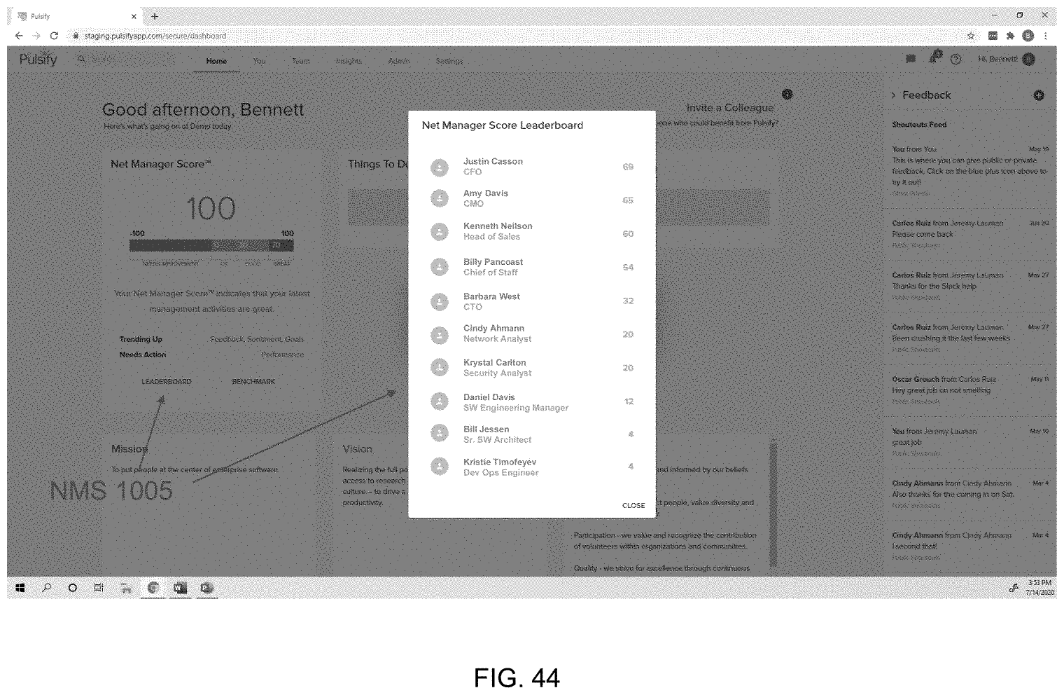

In some embodiments, analytics of the manager augmentation server and system can form a backbone of several unique features of the service. In some embodiments, the analytics can allow managers to do individual sentiment checks, and then determine whether there are trends at the individual and team levels which could lead to actionable issues. In some embodiments, by identifying individual employee trends, the manager augmentation server and system can enable a manager to have better visibility into that employee's state of mind, and thereby determine whether an individual plan is necessary (see for example FIGS. 5 and 6, and discussed further below). In some embodiments, this kind of feedback can be particularly unique since this type of individual-level insight cannot be obtained in any other way, and can have broad impact on the organization. Further, in some embodiments, by identifying team trends, a manager can address systemic issues that may be affecting all or part of a team.

In some embodiments, the manager augmentation server and system can generate one or more system dashboards or displays. For example, some embodiments illustrate the power of being able to look at feedback over time to determine if there are actionable issues. In some further embodiments, the manager augmentation server and system can enable a user (e.g., such as a manager) to examine team-level trends. For example, in some embodiments, the manager augmentation server and system can utilize an accumulation of individual trends to identify team-level issues. Some embodiments provide trend analyses chart displays that show the distribution of reasons and risk as reported for the overall team. This can be very insightful to identify team-level problems that could lead to remediation actions applicable to the whole team. In some embodiments, the user can glean these insights by studying these visualizations and the insights in dashboards.

For example, in reference to FIG. 5, illustrating a team dashboard or display 500 in accordance with some embodiments of the invention, including, but not limited to, a team assessment overview window 510, and/or a team window 550, and/or a concerns/learning window 570. In some embodiments, the team assessment overview window 510 can comprise an assessment overview chart, and/or a key metrics display, and/or sentiment statistics. In some embodiments, the team assessment overview window 510 can comprise a rating, sentiment, or feeling that is signified using one or more colors of text and/or graphics or icons of a specific color or colors as described earlier. In some embodiments, a sentiment distribution chart can be included using bars with the same or similar colors of text and/or graphics or icons. In some embodiments, the key metrics display of the team assessment overview window 510 can include an alert using one or more colors of text and/or graphics or icons.

In some embodiments, a misalignment can be represented by a shading difference of a color of text and/or graphics or icons. In some embodiments, the assessment overview chart, and/or a key metrics display, and/or sentiment statistics can include the number of employees that have been determined to be misaligned, and/or the number of employees who have been determined to be at-risk. In some further embodiments, any one of the assessments performed by an employee and/or a manager of the employee can be used to evaluate promotion of the employee, compensation of the employee, and/or can be used in an evaluation of whether to keep an employee or whether to fire an employee.

In some embodiments, the employee window 550 can include the last sentiment of one or more employees of a team. In some embodiments, the last sentiment can comprise a rating, sentiment, or feeling can be signified using one or more colors of text and/or graphics or icons of a specific color or colors as described earlier. In some embodiments, the employee window 550 can include an alert using one or more colors of text and/or graphics or icons associated with the last sentiment. For example, in some embodiments, an alert comprising one or more colors of text and/or graphics or icons can indicate a declining sentiment and/or a recently updated sentiment.

In some embodiments, the concerns window 570 comprises a section related to identifying concerns that apply to one or more team members and presenting coaching material to the manager to assist them in addressing these concerns. In some embodiments, the concerns window 570 comprises a section that identifies one or more team-level concerns 571, a section 572 that presents root causes that are typically associated with the identified concern, and a section 573 that contains manager coaching material associated with a root cause. The manager may select a root cause and specific coaching material will be presented in section 573.

Some embodiments include guidance features to help managers think-through, evaluate, and take actions that address areas of concern with their employees. In some embodiments, this can expose the manager to management best practices from several sources that are targeted to the specific situations he or she is currently dealing with. For example, some embodiments include one or more reasons for misalignment on overall sentiment, including categories in discussing employee titles, and/or discussing employee compensation, and/or rebalancing employee resourcing, in addition to latest sentiment display.

In some embodiments, the manager augmentation server and system can identify and evaluate a manager misalignment with one or more employees as a function of time. In some embodiments, the manager augmentation server and system can be used to identify manager misalignment for focus by an organization, and/or a manager's manager.

In some embodiments, reasons that are selected by a manager can be linked to a guidance section, including, but not limited to a display that can comprise an employee's titles display section and/or creating growth plans for the employee's section. In some embodiments, guidance can be defined as a list of root causes or common reasons for the identified concern by the manager. In some embodiments, each of the root causes can be selected to open additional, more detailed content that helps the manager learn about that topic of interest. In some embodiments, content could include, but not be limited to articles, webinars, videos, research papers, studies, worksheets, and other education media content, etc. For example, in one embodiment, assuming the manager selects or clicks on a link for a desire for higher compensation, then information, education, and/or strategies related to compensation can appear on the manager's display.

In some embodiments, machine learning can be used to select targeted content based on a specific selection and/or value of the content, where machine learning can be used to update the content based on a specified or quantified value. For example, in some embodiments, the managers can select whether the article was helpful (via a vote up or down type command). Further, in some embodiments, the next time they hit this same issue and root cause and click on the guidance topic, a different article can appear. The platform will record which articles have been seen by which managers and will show the most highly rated articles that have yet to be seen.

In some embodiments, guidance can be delivered in a way that (1) provides insight into what guidance material was selected by the manager for specific situations, and (2) determine if the material chosen was effective. In some embodiments, the feedback can be pulled back into the platform where system algorithms can be improved in an on-going and real-time manner, where the system becomes smarter and more powerful with each piece of data collected and guidance suggested.

In some embodiments, the manager augmentation server and system can be used to enable a service provider's customers to conveniently provide feedback on the service provider's performance. In some embodiments, such customers can be automatically prompted on a periodic basis as desired by the provider, the customer or both

In some embodiments, artificial intelligence techniques can be used for decision support through the guidance process by analyzing data trends and user feedback, providing the most appropriate information to the user, and suggesting courses of action.

In some embodiments, the manager augmentation server and system can be used to support determining one or more disconnects between a manager and one or more employees. In some further embodiments, the manager augmentation server and system can be used to determine when and how guidance is shown to managers. In some other embodiments, the manager augmentation server and system can be used to determine the guidance content that is clickable. In some embodiments, the manager augmentation server and system can be used to support evaluating effectiveness of guidance techniques.

Some embodiments include an assessment overview with a display related to a team average rating (shown as a “doing great” rating icon) and/or a sentiment distribution (e.g., represented as the sentiment bar chart included on the team dashboard or display 500. Further, in some embodiments, the display can include sentiment assessments including, but not limited to, an “overdue sentiment” display, and/or a sentiment targets display (e.g., such as with the inclusion of a frequency and/or completion display). In some further embodiments, the display can include the latest sentiment display, including the latest sentiment of one or more employees, including, but not limited to, employee title, and information showing recent sentiments and last sentiments.

FIG. 6 illustrates an individual employee's display 600 in accordance with some embodiments of the invention. In some embodiments, the individual employee's display 600 can include a display portion 610 where the manager can view his or her employee's sentiment history, rating or sentiment summary comprising a rating, sentiment, or feeling that is signified using one or more colors of text and/or graphics or icons of a specific color or colors as described earlier. Further, some embodiments also include a list of one or more associated reasons that the manager has previously selected for any specific rating, sentiment, or feeling based upon the check-in between the employee and manager. In some further embodiments, a notes section can be included in the display portion 610 and can be used for notes or other related information. In some embodiments, the concerns window 630 comprises a section that identifies one or more identified employee concerns 631, a section 632 that presents root causes that are typically associated with the identified concern, and a section 633 that contains manager coaching material associated with a root cause. The manager may select a root cause and specific coaching material will be presented in section 633.

Some embodiments include manager coaching material that can be one or more links or articles to news, social media, videos, or other media content, articles, or links related to assisting a manager to address one or more employee concerns. In some embodiments, a machine learning function of the manager augmentation server and system can learn from employee behavior including manager selection of one or more links or articles to news, social media, videos, or other media content, articles, or links related to assisting a manager with addressing one or more employee concerns. In some embodiments, the one or more links or articles to news, social media, videos, or other media content, articles, or links related to assisting an employee with addressing one or more concerns can be continuously or intermittently updated based on the machine learning. In some embodiments, the manager augmentation server and system can be continuously improved using feedback from the machine learning of the system.

In some embodiments, the assessment overview information can be assimilated into a set of analytics across every period for every employee in every organization. In some embodiments, the analytics can be derived from information in the database. This information then becomes the foundation for recommendations and benchmarks. In some non-limiting embodiments, for each period, the analytics can include team level items including rating count by rating, and/or number rated, and/or team size, and/or organization size, and/or concern count by concern, and/or at-risk concern count by concern. In some embodiments, for each period, the analytics can include direct level items including rating count by rating, and/or number rated, and/or team size, and/or organization size, and/or concern count by concern, and/or at-risk concern count by concern. In some embodiments, for each period, the analytics can include peer level items including rating count by rating, and/or number rated, and/or team size, and/or organization size. In some embodiments, for each period, the analytics can include a peer's direct level items including rating count by rating, and/or number rated, and/or team size, and/or organization size. In some further embodiments, for each period, the analytics can include company level items including rating count by rating, the number rated, and/or the team size, and/or the organization size. In some other embodiments, for each period, the analytics can include a direct level item, including rating count by rating, and/or number rated, and/or team size, and/or organization size.

In some embodiments, the analytics can include company level items including the organization sentiment average and can include the teams with the highest ratings, and teams with the lowest ratings. In some embodiments, the analytics can include company level “at-risk” percentages over time and can include a list of teams with the most “at-risk” percentage. In some embodiments, the analytics can include company level misalignment, including the total number of misaligned employees and can include a list of teams with the most misalignment. In some embodiments, the analytics can include company level manager usage percentages and can include the top usage employees and lowest usage employees. In some embodiments, the analytics can include company level team self-reporting, including the total number of responses and can include the top response employees and the lowest response employees. In further embodiments, the analytics can include company level trending issues, including the most viewed articles to news, social media, videos, or other media content, articles, or links related to assisting an employee with addressing one or more concerns.

In some embodiments, the manager augmentation server and system can use a combination of analytics-driven logic and machine learning techniques to identify at-risk employees. In some embodiments, the analytics-driven logic can use several periods of assessments in its determination of at-risk employees, and can rely on the overall rating. In some embodiments, employee-level trends can focus on identifying at-risk employees, such as at-risk employees who have personal and/or work-related issues that are affecting their performance and happiness.

In some embodiments, benchmarks can be used by a manager to compare the relative health of their team compared to other teams and to help them determine trends that might indicate issues that should be addressed proactively. In some embodiments, the benchmarks can use empirical results, analytical (calculated) results, and periods over a certain timeframe. In some embodiments, the following analytical values can be available for benchmarks, and can be shown in the portal: rating count by rating, and/or number rated, and/or team size, and/or organization size, and/or reason count by reason, and/or at-risk reason count by reason. In some embodiments, the benchmarks can be used for comparative purposes, and the following levels of comparison can be available in the portal: employees, and/or manager, and/or manager peers, and/or organization peers, and/or company-wide. In some further embodiments, benchmarks can be used to project future behavior by analytically examining the trend contained in one or more of the at-risk trend or the turnaround trend.

In some embodiments, the analytics and benchmarks can be used to benchmark assessment reasons which in turn are used to suggest recommendations that provide approaches, strategies, and/or specific actions to help improve an employee's disposition. In some embodiments, the manager augmentation server and system can use one or more analytics-driven logic and machine learning techniques to suggest recommendations to help the manager address issues identified during the assessments. One of the goals of the service is to identify recommendations that help a manager proactively address issues that an employee might be having. In some embodiments, the service can use machine learning to determine if one or more recommendations should be suggested for an employee.

In some embodiments, the recommendations can be created by analyzing the assessment data as well as overall company trends, industry trends, and other 3rd party information. In some embodiments, the recommendations can cover a specific topic that is meant to address a problem or issue that is associated with an assessment reason. In some embodiments, to trigger a recommendation, a set of conditions must be met. In some embodiments, recommendation actions are approaches, strategies, and/or specific actions that can be taken by a manager to improve an employee's disposition, and possible success in their role. These can be tailored by the employee role. For example, sales personnel may have different actions than software engineers. Further, each company may tailor their actions based upon their own employee guidelines and practices.

In some embodiments, predicting at-risk employees using analytical techniques involves looking at an employee's ratings over time along with the assessment reasons given. At-risk is not a binary state since an employee just starting in the at-risk category is different than one who has been in that classification for an extended time-period. As a result, there are two at-risk classifications: Watch classification and Alert classification. Watch classification is used for employees identified as at-risk start off in the “Watch” classification. This classification may be temporary and indicates a period when mitigation may be the most effective. An employee is classified as “Watch” for one of the following reasons: an employee has just transitioned into an orange or red rating, and/or an employee has just transitioned into yellow plus has one or more assessment reasons from a prescribed list of reasons. In some embodiments, for an “Alert” classification, employees can be moved into the “Alert” classification for one of the following reasons: an employee who has been in the “Watch” classification for three or more consecutive periods, and/or an employee who has had a red rating for two or more consecutive periods are considered in the “Alert” category.

Some embodiments can include selecting and making recommendations. In some embodiments, selecting recommendations can involve using analytical techniques to analyze an employee's ratings and associated assessment reasons over time. In this instance, an employee does not need to be classified as at-risk to trigger one or more recommendations. In some embodiments, analytics-based recommendations can be selected based upon “triggers”. In some embodiments, the trigger for a recommendation is backed by a formula that is based upon one or more analytical statistics. An example can include a trigger when a reason has been selected X times within a Y period or periods, and/or when one of a set of reasons has been selected X times within a Y period or periods. Other examples include a trigger when more than one from a set of reasons has been selected X times within a Y period or periods, and/or when an employee is at-risk for X times within a Y period or periods. Another example can be a trigger when an employee is at-risk and a reason has been selected for X times within a Y period or periods.

An example of one recommendation is shown in the Table 1 below:

TABLE 1
Recommendations table

| | | RECOMMENDATION | |
|---|---|---|---|
| REASONS | ROOT CAUSES | ACTION | RULE |
| Compensation | Employee tenure | Links for each root | When mentioned 3 |
| | length without much | cause that provide | consecutive weeks |
| | change | additional articles, | in a row or within a |
| | Desire for higher | videos, courses, etc. | 6-week period |
| | compensation | | |
| | Witnessing promotion | | |
| | of peers | | |
| | Desire for growth and | | |
| | learning management | | |
| | Long-term goals and | | |
| | intended trajectory | | |

In some further embodiments, the manager augmentation server and system can support a manager with an option to add free-form notes to provide additional context for the assessment. In some embodiments, a note can be marked as private if the manager feels that it should not be seen by either his or her team members, other managers, or his or her superiors. In some embodiments, notes can be stored in the database. In some embodiments, all assessments are visible to any manager up the organization within the same reporting line, but cannot be viewed by anyone else in the organization. In some embodiments, for each of their team members, managers can see historical ratings and reasons as well as a summary of the comments for each person. In some embodiments, managers can also ‘tag’ any person by clicking on the star by their name which makes it so that they will automatically show up on the manager's dashboard under key updates. Similarly, in some embodiments, a manager can click on the people icon to jump into a person's profile on the manager's organization.

Some embodiments include adoption summaries that show a percentage of assessments performed across the manager's organization. Further, in some embodiments, it also shows the percentage of assessments performed across the manager's peer group and the company as a whole for comparison purposes.

In some embodiments, the manager augmentation server and system dashboard or display can show several of the key findings and metrics in one place. In some embodiments, the following information can be shown in “widgets” on the dashboard or other type of display format. In some embodiments, directs can be shown as a list of direct reports with their last assessment rating. In this instance, a user can select one and go directly to that employee. In some further embodiments, usage performance can show the percentage of assessments performed compared to peers and company. In this instance, a user can link to the more complete view of these metrics. In some embodiments, key updates can include any tagged employees, those that have changed assessment ratings and become at risk, and the last ten rated employees. A user can select one and go directly to that employee. In some further embodiments, an at-risk feature can provide a list of employees who are considered at-risk. In some embodiments, a user can select one and go directly to that employee's profile. In some embodiments, the risk benchmark can provide a benchmark of user's assessment ratings over time compared to peers and company. In some embodiments, a user can link to the more complete view of these metrics. In some embodiments, the top reasons can show the top three assessment reasons of at-risk employees. In some embodiments, a user can also link to the more complete view.

For example, some non-limiting examples of analytics of the manager augmentation server and system are shown in FIGS. 6A-6I. In some embodiments of the invention, the manager augmentation server and system can calculate and display one or more trends of sentiment. For example, FIG. 6A illustrates a sentiment trend chart in accordance with some embodiments of the invention. In some embodiments, the sentiment trend can be shown for one or more functions or part of a company or team. For example, the non-limiting embodiments of FIG. 6A shows sentiment plots for information technology, operations, sales and marketing, and finance portions of a company, teams or groups. In some embodiments, a company benchmark of sentiment can be shown.

In some embodiments of the invention, the manager augmentation server and system can calculate and display one or more sentiment distribution statistics. For example, FIG. 6B illustrates a sentiment distribution chart in accordance with some embodiments of the invention. In some embodiments, the sentiment distribution can be shown as a function of one or more of the aforementioned sentiment rating, including, but not limited to, “not good”, “struggling”, “so-so”, “mostly ok”, and “doing great”. In some embodiments, each distribution can be shown as a sentiment color as described earlier.

In some embodiments of the invention, the manager augmentation server and system can calculate and display statistics of reasons. For example, FIG. 6C illustrates a cumulative reasons chart in accordance with some embodiments of the invention. In some embodiments, a cumulation bar chart can represent positive and/or negative sentiment cumulatively represented by the relative lengths of the bars for each reason (y-axis).

In some embodiments of the invention, the manager augmentation server and system can calculate and display statistics of cited reasons. For example, FIG. 6D illustrates a reasons trend chart in accordance with some embodiments of the invention. As shown in this non-limiting embodiment, in some embodiments, cumulative cited reasons (y-axis) can be shown as a function of negative reason or positive reason, and a trend line can be shown for each.

In some embodiments of the invention, the manager augmentation server and system can calculate and display statistics of at-risk trends. For example, FIGS. 6E-6F illustrate at-risk trend charts in accordance with some embodiments of the invention. As shown in FIG. 6E, in some embodiments, the at-risk trend can be shown for one or more functions or part of a company or team. For example, at-risk plots of information technology, operations, sales and marketing, and finance portions of a company, teams or groups can be calculated and displayed. In some embodiments, a company benchmark of sentiment can be shown. In reference to FIG. 6F, in some embodiments, at-risk trend data can be shown and/or misalignment can be calculated and displayed. In some embodiments, these trends can be displayed as a function of time as shown. Further, in some embodiments of the invention, the manager augmentation server and system can calculate and display statistics of misalignments in sentiment and trends. For example, FIGS. 6G-6H illustrate misaligned trend charts in accordance with some embodiments of the invention. In some embodiments, sentiment misalignment can be shown as a function of one or more functions or part of a company or team. For example, plots of information technology, operations, sales and marketing, and finance portions of a company, teams or groups can be calculated and displayed. In some embodiments, a company benchmark of sentiment can be shown. Further, as shown in FIG. 6H, in some embodiments, aligned or misaligned data can be shown as a function of time.

In some embodiments of the invention, the manager augmentation server and system can calculate and display statistics of sentiment behavior. For example, FIG. 6I illustrates an assessment trends chart in accordance with some embodiments of the invention. In some embodiments, the sentiment statistics can be shown for one or more functions or part of a company or team. For example, plots of information technology, operations, sales and marketing, and finance portions of a company, teams or groups can be calculated and displayed. In some embodiments, a company benchmark of sentiment can be shown.

In some embodiments, the manager augmentation server and system dashboard or display can serve as the “home” page for the manager, and can provide a focused view of their organizational health. In some embodiments, each of the visualizations on the dashboard or display can serve a different purpose. For example, in some embodiments, frequent and regular assessments are an important tool to improve communication and trust with employees and to deal with issues early before they become major problems. In some embodiments, a usage performance information window or widget can show how well the organization is completing its assessments and/or can encourage continued use. Since it is difficult to track changes in an organization, especially significant ones like an employee's declining assessment rating, a key updates widget can identify employees where their rating has changed, and can also show employees that a manager has tagged for tracking. Further, in some embodiments, an organization's at-risk employees can be shown in the at-risk widget as a way of highlighting employees requiring special attention. In some embodiments, a risk benchmark widget can show the manager's organizational average rating compared to their peer and company averages, giving the manager a quick pulse of their organization. In some embodiments, one or more reasons for an employee being at-risk are important to understand what might be happening, and in determining how to address the situation. In some embodiments, a top reasons widget can represent the top reasons associated with at-risk employees in the manager's organization.

In some embodiments, the manager augmentation server and system can include creation of a company account, and all employees in a company can share the email domain of the company. In some embodiments, a company must first be defined in the manager augmentation server and system by entering a valid email domain which is stored in the database. In some embodiments, when a user first accesses the portal, they can be asked to register by providing their employee email, name, and title (e.g., see portal 715 of FIG. 7). In some embodiments, before a company can use the manager augmentation server and system, the new email domain must be registered by an administrator of manager insight and learning system. In some embodiments, if the email domain is defined in the system, then an entry will be created in the authentication manager augmentation server and system for the user that will be marked “pending”.

In some embodiments, to verify an employee's email address, the manager augmentation server and system can send an email to the employee email which contains an expiring code that they must enter into the portal. In some embodiments, when this is done successfully, the user's status in the database changes from “Pending” to “Active”, and the user can log into the service. In some embodiments, employee teams are a critical relationship within the service and are often used for analytics and benchmarks. In some embodiments, teams can be determined organically within the manager augmentation server and system using one or more of the mechanisms outlined as follows. In some embodiments, the manager augmentation server and system can set up the team where a manager initially sets up the directs on their team, and the portal provides the ability to specify the employees on his or her team by entering the employees' email addresses. In some embodiments, if an employee with the specified employee email is not shown in the database, the manager must enter the employee's name and title which is entered into the database, and the employee's manager is set to the manager.

FIG. 7 illustrates a service component architecture 700 of the manager augmentation server and system in accordance with some embodiments of the invention. In some embodiments, the service component architecture 700 can illustrate the primary components in the service architecture, and how they relate to each other. In some embodiments, the service can be delivered as a SaaS (Software as a Service) application and can be deployed at Amazon® Web Services (“AWS”), or other conventional cloud-based service. In some embodiments, the blocks 710, 715, 720, 725, 730, 735 represent the primary components in the architecture. In some embodiments, the arrows represent the main data flow between them that is implemented as a “RESTful” API. Each arrow represents a different API and identifies which components communicate using the API. In some embodiments, the numbered APIs are described in more detail in the sections which follow.

Unless specified or limited otherwise, the term “service” refers to the total software, database, algorithms, and user interface that creates the functionality provided by the system. Unless specified or limited otherwise, the database can be a “NoSQL” (or “non-SQL” or “non-relational”) 735 or a “SQL” (“relational”) database that provides a mechanism for storage and retrieval of data. In some embodiments, the database can warehouse the objects and relationships that represent the components of the system. In some embodiments, the database structure includes tables that are comprised of items and indices.

Unless specified or limited otherwise, “microservices” refers to software that embodies the logic of the service organized as a suite of component services, each running in its own process and communicating with HTTPS using a “REST” application program interface (“API”), and deployed by a fully automated deployment mechanism. Some embodiments include a machine learning method of data analysis that automates analytical model building used to predict future behavior and/or outcomes. Unless specified or limited otherwise, a “portal” can be a user interface utilized by users of the service. Unless specified or limited otherwise, users can be service users. Unless specified or limited otherwise, analytics define algorithmic results derived from analyzing data in the database and/or third-party sources. Unless specified or limited otherwise, benchmarks can be analytic results viewed over a time-period that are used for comparative purposes. Unless specified or limited otherwise, recommendations can consist of recommended approaches, strategies, and/or specific actions to help manage and lead that are based upon the ratings and reasons entered for an employee's personal situation.

In some embodiments, the authorization service 710 can be used to authenticate all users of the service. In some embodiments, the authorization service 710 can provide secure sign-up and sign-in functionality and can scale to support hundreds of millions of users, and can provide optional security features such as email and phone number verification, and multi-factor authentication. In some embodiments, the primary technology used for the authorization service is “Security Assertion Markup Language” (SAML). This technology enables single sign-on whereby users may log in using their corporate credentials and will be validated by their employer's SAML authentication and authorization service 710. Once authorized, the authentication and authorization service will pass the identity of the user to the platform which will then be able to provide the service to the user.

In some embodiments, a server running the portal user interface (“portal UI” 715) can provide browser-based service access to users, including, but not limited to inclusion on a mobile application for mobile users. In some embodiments, user service access can be via embedded Add-ons and Add-ins. For example, a Microsoft® Outlook Add-in can be made available to users to provide access to the service. In some embodiments, this is the primary user interface for users. In some embodiments, the portal UI 715 supports normal wide screen access from laptops, etc., and also provides an optimized version for mobile devices. In some embodiments, the primary technologies used for the implementation of the portal UI 715 can be React and JavaScript. In some embodiments, the primary API used by the portal UI 715 can be the microservices API 720, and are the server side of the service. In some embodiments, when the UI needs information from the database or to perform an action like create an employee or send an email, it can use the microservice API 720.

In some embodiments, the server-side software can be implemented using a no-server design. This means that the server-side logic can be implemented using microservices that are deployed and executed on an as-needed basis. This allows for flexible scaling of resources based upon an increase or decrease of demand. In some embodiments, the microservice RESTful API can use a technology called GraphQL for the API protocol. GraphQL is an API query language, developed by Facebook Inc., that defines a syntax to specify the query type and exactly the data requested. GraphQL provides a very flexible mechanism to extend the capabilities of the API over time without needing to extend the API itself. It also makes it possible for the UI to ask for only the information needed to streamline the amount of data exchanged. In some embodiments, the microservices can support database update and access, including changes to the database itself, and analytics access, including receiving analytics results, and email access, with a trigger sending emails for various purposes.

In some embodiments, the primary technologies used for implementing microservices can be AWS lambda and Node.js®, and the main service database can be a NoSQL (non-relational) database 735. In some embodiments, the database can be accessed by microservices 720 using an API. In some embodiments, the data items in the database can be stored as objects organized into tables, and each company can have its own set of tables. In some embodiments, the main tables can be a domain table providing a list of valid domains supported in the service, an employee table providing a list of employees in a company and hierarchical relationship between them, and an assessment table including all employee assessments for a company.

Several indices can allow quick access to subsets of the data. For example, there can be an index on the employees table that contains a manager ID which allows quick access to a manager's employees. In some embodiments, the primary technology used for the NoSQL database 735 can be AWS DynamoDB.

In some embodiments of the invention, the analytical database 730 can be a read-only database that can store historical data and trend statistics that are key for generating service insights (detailed in section—analytic data). In some embodiments, the trend statistics can summarize results over time for a team or set of teams. For example, the last six months, for each team, the manager augmentation server and system can calculate the number of direct reports who are rated yellow or below in an organization according to some embodiments. In some embodiments, this information can be calculated in real-time and/or in batch mode, and the results can be stored in the analytical database 730 to improve performance and/or simplify more complex algorithms. In some embodiments, the machine learning 725 can rely on the analytics in this database. In some embodiments, the analytical database 730 can be queried using SQL queries by microservices over an API. In some embodiments, the analytical database 730 can be created from the data in the NoSQL database 735 using an API. In some embodiments, the primary technology used for the analytics database is AWS® Redshift.

Some embodiments include a machine learning (“ML”) (e.g., component 725) that can be accessed by microservices using an API (720). In some embodiments, the ML component 725 of the service component architecture 700 can be used primarily to identify at-risk employees, select one or more relevant recommendations for an employee, and identify predictive trends of future behavior. In some embodiments, the use of the ML component 725 can be key to learning from the assessment results to determine how best to improve an employee's disposition and select the “best” plan of action. As a result, in some embodiments, the ML component 725 can be used both for features in the service component architecture 700, but also for off-line data mining activities to improve the feedback provided by the service.

FIG. 8 illustrates a computer system 800 configured for operating and processing one or more components of the manager augmentation server and system in accordance with some embodiments of the invention. In some embodiments, the computer system 800 can process one or more software modules of the manager augmentation server and system applications, enabling the computer system 800 to display information related to the manager augmentation server and system within one or more graphical user interfaces (e.g., in one or more of an employee and/or manager displays or dashboards described earlier). In some embodiments, the computer system 800 can process one or more manager augmentation server and system application services. Further, the computer system can also manage the organization of data and data flow between the manager augmentation server and system application services, front end systems and servers, back end systems and servers, and external or remote (third party) computer systems.

In some embodiments, the computer system 800 can comprise at least one computing device including at least one processor 832. In some embodiments, the at least one processor 832 can include a processor residing in or coupled to one or more server platforms. In some embodiments, the computer system 800 can include a network interface 835a and an application interface 835b coupled to the least one processor 832 capable of processing at least one operating system 834. Further, in some embodiments, the interfaces 835a, 835b coupled to at least one processor 832 can be configured to process one or more of the software modules (e.g., such as enterprise applications 838). In some embodiments, the software modules 838 can include server-based software that can include manager augmentation server and system software modules. In some embodiments, the software modules 838 can operate to host at least one user account and/or at least one client account, and operating to transfer data between one or more of these accounts using the at least one processor 832.

With the above embodiments in mind, it should be understood that the invention can employ various computer-implemented operations involving manager augmentation server and system data stored in computer systems. Moreover, the above-described databases and models throughout the manager augmentation server and system can store analytical models and other data on computer-readable storage media within the computer system and on computer-readable storage media coupled to the computer system. In addition, the above-described applications of the manager augmentation server and system can be stored on computer-readable storage media within the computer system and on computer-readable storage media coupled to the computer system. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

In some embodiments of the invention, the computer system 800 can comprise at least one computer readable medium 836 coupled to at least one data source 837a, and/or at least one data storage device 837b, and/or at least one input/output device 837c. In some embodiments, the invention can be embodied as computer readable code on a computer readable medium 836. In some embodiments, the computer readable medium 836 can be any data storage device that can store data, which can thereafter be read by a computer system (such as the computer system). In some embodiments, the computer readable medium 836 can be any physical or material medium that can be used to tangibly store the desired information or data or instructions and which can be accessed by a computer or processor 832. In some embodiments, the computer readable medium 836 can include hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 836 can transmit or carry instructions to a computer 40 and/or at least one user 831, including a router, private or public network, or other transmission device or channel, both wired and wireless. The software modules 838 can be configured to send and receive data from a database (e.g., from a computer readable medium 836 including data sources 837a and data storage 837b that can comprise a database), and data can be received by the software modules 838 from at least one other source. In some embodiments, at least one of the software modules 838 can be configured within the computer system to output data to at least one user 831 via at least one graphical user interface rendered on at least one digital display.

In some embodiments of the invention, the computer readable medium 836 can be distributed over a conventional computer network via the network interface 835a where the manager augmentation server and system embodied by the computer readable code can be stored and executed in a distributed fashion. For example, in some embodiments, one or more components of the computer system can be coupled to send and/or receive data through a local area network (“LAN”) 839a and/or an internet coupled network 839b (e.g., such as a wireless internet). In some further embodiments, the networks 839a, 839b can include wide area networks (“WAN”), direct connections (e.g., through a universal serial bus port), or other forms of computer-readable media 836, or any combination thereof

In some embodiments, components of the networks 839a, 839b can include any number of user devices such as personal computers including for example desktop computers, and/or laptop computers, or any fixed, generally non-mobile internet appliances coupled through the LAN 839a. For example, some embodiments include personal computers 40 coupled through the LAN 839a that can be configured for any type of user including an administrator. Other embodiments can include personal computers 840 coupled through network 839b. In some further embodiments, one or more components of the computer system can be coupled to send or receive data through an internet network (e.g., such as network 839b). For example, some embodiments include at least one user 831 coupled wirelessly and accessing one or more software modules of the manager augmentation server and system including at least one enterprise application 838 via an input and output (“I/O”) device 837c. In some other embodiments, the computer system can enable at least one user 831 to be coupled to access enterprise applications 838 via an I/O device 837c through LAN 839a. In some embodiments, the user 831 can comprise a user 831a coupled to the computer system using a desktop computer, and/or laptop computers, or any fixed, generally non-mobile internet appliances coupled through the internet 839b. In some further embodiments, the user 831 can comprise a mobile user 831b coupled to the computer system. In some embodiments, the user 831b can use any mobile computing device 831c to wireless coupled to the computer system, including, but not limited to, personal digital assistants, and/or cellular phones, mobile phones, or smart phones, and/or pagers, and/or digital tablets, and/or fixed or mobile internet appliances. In some embodiments, a user can use the display of a mobile device (e.g., such as a smart phone) to select a person and/or to enter an overall rating. Further, in some embodiments, the mobile display can be used to select the employee's drivers, and can be used to update the file with notes. In some embodiments, any of the mobile displays can be used to display at least a portion of any of the display, windows, or widgets shown and described herein.

In some embodiments, the computer system 800 can enable one or more users 831 coupled to receive, analyze, input, modify, create and send data to and from the computer system, including to and from one or more enterprise applications 838 running on the computer system. In some embodiments, at least one software application 838 running on one or more processors 832 can be configured to be coupled for communication over networks 839a, 839b through the internet 839b. In some embodiments, one or more wired or wirelessly coupled components of the network 839a, 839b can include one or more resources for data storage. For example, this can include any other form of computer readable media in addition to the computer readable media 836 for storing information, and can include any form of computer readable media for communicating information from one electronic device to another electronic device.

In some embodiments, the primary technology used for the ML engine is AWS® machine learning. The ML model used is the multi-class classification model. For training multiclass models, Amazon® ML uses the industry-standard learning algorithm known as multinomial logistic regression. FIG. 9 shows a machine learning for an at-risk employee architecture of the manager augmentation server and system in accordance with some embodiments of the invention. For machine learning, it is first necessary to train the ML model using data with a known outcome. In some embodiments, the model training for predicting at-risk employees involves using data from past assessment ratings (e.g., see input from databases 910, 920), including employees that have left the company, and/or employees that have steadily declining ratings, and/or employees that have reasons that are known to be particularly problematic, and/or employees that move to another team for non-business reasons. Using this information, to set the “at-risk” target attribute in the training data (training module 915) allows the model (925) to train on that attribute. In some embodiments, the model is improved over time as more data is accumulated, especially data related to employees that leave the company. In some embodiments, this illustrates ML training and deployment applied to the problem of determining which recommendations should be suggested for an employee. In some embodiments, the model training for predicting recommendations involves using the following data from past assessments including recommendations that were manually selected by a manager, and employees that have reasons that are known to be particularly problematic. Using this information to set the “recommendation” target attribute in the training data allows the model to train on that attribute. In some embodiments, the model is improved over time as more data is accumulated, especially by feedback steps including a first feedback when a manager is presented with recommendation suggestions and is asked to select one or more that are relevant for that employee's situation, where the selections that he or she makes will reinforce the correct selection for that situation. In some embodiments, a second feedback includes the service following up with a manager and to ask him/her to rate the effectiveness of the recommendation that had been selected for that employee. In some embodiments, both of these feedback loops can provide a useful result on which the model may be trained further. Some embodiments implement a modern server-less API architecture (real-time prediction API 930 couple to service API 935) which can be scaled as necessary to match the demands of a growing service for one or more users 940.

In some embodiments, the manager augmentation server and system can be scaled. For example, in some embodiments, the infrastructure scaling can be achieved by the architecture chosen (e.g., see service component architecture 700 of FIG. 7). The main scaling components can be microservices and the NoSQL or relational database as shown. Microservices spawn a function for every request from the portal UI, and there is no practical limit to the number of microservice functions that can be created. In some embodiments, the NoSQL database can use a cluster implementation that can be scaled based on the number of simultaneous read and write requests, and there is no practical limit since the cluster is designed to scale as needed.

Some embodiments can utilize AWS components that implement the service components shown in FIG. 10 (architecture 1000), showing a machine learning for an at-risk employee architecture of the manager augmentation server and system in accordance with some embodiments of the invention. This design implements a modern server-less API architecture which can be scaled as necessary to match the demands of a growing service, and include one or more coupled servers, databases, and API's, including, but not limited to a scalable cloud Domain Name System (DNS) web service Amazon® Route 53 (1012). Amazon® API Gateway (1018) is a fully managed service that makes it easy for developers to create, publish, maintain, monitor, and secure APIs at any scale. In some embodiments, the architecture 1000 can comprise an API Gateway that is integrated with AWS Lambda (1020). Some embodiments include a monitoring and management service such as Amazon® CloudWatch (1026), a notification service such as Amazon® Simple Notification Service (1032), a content delivery network (CDN) service that securely delivers data, videos, applications, and APIs to customers such as Amazon® CloudFront (1024). Some embodiments utilize Amazon® Cognito (1014), and/or a simple email service (1022). Some embodiments include Amazon® Machine Learning (1016) that provides visualization tools and wizards that guide you through the process of creating ML models. Some embodiments include a fully managed proprietary NoSQL database service that supports key-value and document data structures and is offered by Amazon.com as part of the Amazon Web Services portfolio such as Amazon® DynamoDB (1028). Some embodiments include Amazon® S3 (1034) (Amazon® Simple Storage Service) which is a “simple storage service” offered by Amazon® Web Services that provides object storage through a web service interface, and provides a web interface to easily store and retrieve data safely. Some embodiments include the use of at least one data pipeline (1030). Amazon® is a registered trademark of Amazon® Technologies, Inc.

The following describes a list of the main software tools used for the development of the service. Some embodiments include JavaScript ReactJS (1010). ReactJS supports building encapsulated components in JavaScript that manage their own state that are used to compose complex UIs. This allows a true object-oriented approach to building the service's UI. Some further embodiments utilize GraphQL, a query language for APIs and a runtime for fulfilling those queries with existing data. The GraphQL provides a complete and understandable description of the data in your API, gives clients the power to ask for exactly what they need and nothing more, makes it easier to evolve APIs over time, and enables powerful developer tools. Some further embodiments utilize Node.js®, a JavaScript runtime built on Google's V8 JavaScript engine. Node.js® uses an event-driven, non-blocking I/O model that makes it lightweight and efficient. Some other embodiments utilize Git™, a version control system for tracking changes in computer files and coordinating work on those files among multiple people. Node.js® is a registered trademark of the Node.js Foundation. Git™ “Git and the Git logo are either registered trademarks or trademarks of Software Freedom Conservancy, Inc., corporate home of the Git Project, in the United States and/or other countries.” when you need to mention “Git” in e.g. list of trademarks held by other people

In some embodiments, if the employee and manager ratings have been determined to be significantly different (using one or more of the analytical techniques mentioned previously), the manager augmentation server and system can notify the manager on the platform that there is a misalignment, and they need to “dig in” or further analyze with the employee (without providing the specifics and violating the employee confidentiality.) In some embodiments, once that manager meets with that employee and determines one or more reasons for the misalignment, they can update/correct their initial rating in the platform, and any new actions and recommendations can be generated for that specific employee.

As described earlier, in some embodiments, the manager augmentation server and system can generate one or more system dashboards or displays. For example, FIG. 11 illustrates a dashboard display according to some embodiments of the invention.

In some embodiments, the manager augmentation server and system can enable users to initiate a goal setting online or offline. FIG. 12 illustrates an annual goal setting display page according to some embodiments of the invention. In this non-limiting example embodiment, this can be done via email where employee gets email to start the process. Further, FIG. 13 illustrates a set annual goals display page according to some embodiments of the invention. In some embodiments, an employee can open a modal to enter information for submission.

FIGS. 14-15 illustrate goal approval display pages according to some embodiments of the invention. In some embodiments, employee submitted information can end up in a manager's portal under a goals section, and a manager can edit, remove, and add any goals. Further, in some embodiments, a manager can select a ‘review team goals’ tab to see goals of his/her manager and their direct reports team's goals (one level up and one level down) to ensure employee submitted information is consistent. Further, FIG. 16 illustrates a goal review display page according to some embodiments of the invention. In some embodiments, the display pages of FIGS. 15 and 16 clearly illustrate that users can see the level above and below the person submitting goals to make sure that what they submitted is consistent with what needs to get done to be successful.

In some embodiments, artificial intelligence methods can help streamline the feedback process by providing a number of feedback selections which can be context-driven and tailored to the particular work performed. In some embodiments, the feedback selections can be edited by the feedback provider. Other embodiments may require a selection of pre-populated feedback options to help ensure compliance with applicable laws, regulations, and organizational policies. Some embodiments also enable a value demonstrated by the employee to be selected or entered. Some embodiments also enable the feedback to be private or public as desired.

FIGS. 17A-17G illustrate display pages related to feedback in accordance with some embodiments of the invention. For example, FIG. 17A depicts integration of a feedback module with an email communication program such as Google® Mail (gmail). Other embodiments can comprise integration of a feedback module with Microsoft® Outlook®, Slack, and other conventional email and/or communication programs. In some embodiments, a user can view streams of real-time feedback occurring across an entire organization, a user's team, and/or from or to a user.

Referring to FIG. 17B, in some embodiments, if a user selects ‘new feedback’, the manager augmentation server and system can send feedback to anyone by entering recipient, the type of feedback it is, and the actual feedback. Further, in some embodiments, the user can be enabled to choose to make it public, where the feedback can end up in the everyone or team streams as relevant.

Referring to FIG. 17C, in some embodiments, back in the manager portal, all of the feedback on an individual is aggregated in the new feedback tab positioned at the top. In some embodiments, the feedback can be grouped by what was selected when it was entered (praise, accomplishments, etc.)

Referring to FIG. 17D, in some embodiments, on the dashboard, feedback can now appear in the alerts stream. Referring to FIG. 17E, in some embodiments, the manager augmentation server and system can position a feedback tab at the top of the display that shows a similar view to the Outlook add-in display, etc., where a user can see the various streams.

Referring to FIG. 17F, in some embodiments, on the tab on the left navigation, added analytics can be included. In some embodiments, at the top, some metrics and teams with the most praise can be shown. Further, the next section can enable a user to view various data feeds by organization (e.g., to see which team may have the least amount of feedback and can be in need of some feedback). Further, referring to FIG. 17G, in some embodiments, at the bottom, the manager augmentation server and system can position another chart that allows a user to view which employees are giving the most praise or least praise, etc.

FIG. 18 illustrates a sentiment or rating by time chart according to some embodiments of the invention. Some embodiments include a trendline of manager average rating vs employee average rating. In some embodiments, the difference (delta) shows how far apart they are over time. Accordingly, in some embodiments, the system can enable a user to compare a manager response to an employee response and track how close they are.

FIG. 19 illustrates a “reasons” listing display page according to some embodiments of the invention, and illustrates the top reasons as entered by managers versus employees, and allows users to observe differences.

FIG. 20 illustrates a misalignment distribution display page according to some embodiments of the invention, where system visualizations around misalignments by one or more teams can be shown. In some embodiments, a heat map can be used to visualize a percentage or amount of misalignment. For example, some embodiments can display a percentage of employees misaligned as a function of employee managers. In some embodiments, colors or shades of color can be used to represent various levels or percentages of misalignment. For example, in some embodiments, one or more colors and/or shades of color can be used to represent a percentage or amount of misalignment, and one or more distinct colors and/or shades of color can be used to represent a different percentage or amount of misalignment. In some embodiments, the heat map can include a representation of a percentage or amount of misalignment over a specific time or time span. For example, the non-limiting embodiment of FIG. 20 shows data representing a three-month period. In some embodiments, the heat map can include a representation of a percentage or amount of misalignment for a specific group of employees, a team and/or for an organization.

FIG. 21 illustrates an at-risk distribution display page according to some embodiments of the invention where new visualizations around at risk by one or more teams can be displayed. In some embodiments, a heat map can be used to visualize a percentage or number of at-risk employees. For example, some embodiments can display a percentage of employees misaligned as a function of employee managers. In some embodiments, colors or shades of color can be used to represent various levels or percentages of at-risk employees. For example, in some embodiments, one or more colors and/or shades of color can be used to represent a percentage or number of at-risk employees, and one or more distinct colors and/or shades of color can be used to represent a different percentage or number of at-risk employees. In some embodiments, the heat map can include a representation of a percentage or number of at-risk employees during a specific time or time span. For example, the non-limiting embodiment of FIG. 21 shows data representing a three-month period. In some embodiments, the heat map can include a representation of a percentage or number of at-risk employees for a specific group of employees, a team and/or for an organization.

FIG. 22 illustrates a sentiment usage display page according to some embodiments of the invention, where visualization around manager (upper map) and self-rating usage by one or more teams (lower chart) can be displayed. In some embodiments, a heat map can be used to visualize a percentage or amount of usage. For example, some embodiments can display a percentage of employees misaligned as a function of employee managers. In some embodiments, colors or shades of color can be used to represent various levels or percentages of usage. For example, in some embodiments, one or more colors and/or shades of color can be used to represent a percentage or amount of usage, and one or more distinct colors and/or shades of color can be used to represent a different percentage or amount of usage. In some embodiments, the heat map can include a representation of a percentage or amount of usage during a specific time or time span. For example, the non-limiting embodiment of FIG. 22 shows data representing a three-month period. In some embodiments, the heat map can include a representation of a percentage or amount of usage for a specific group of employees, a team and/or for an organization.

FIG. 23-28 illustrate progress and review display pages according to some embodiments of the invention. As in previously described display pages, in some embodiments, the manager augmentation server and system can ask both a manager and an employee questions, and/or can check on overall performance. Referring to FIG. 23, in some embodiments, the manager augmentation server and system can ask a user (e.g., such as an employee) a question related to how the user feels about their performance during a specific time or span of time. In some embodiments, the question can include or comprise a visual representation of a feeling or sentiment. For example, in some embodiments, the manager augmentation server and system can include a display of a “commanding” icon, “out-performing” icon, “meeting expectations” icon, “falling short” icon, and/or “struggling” icon.

Referring to FIG. 24, in some embodiments, the manager augmentation server and system can ask both a manager and an employee to rate progression against goals. In some embodiments, the manager augmentation server and system can include a display of one or more goals, a due-by date for the one or more goals, and one or more selectable answers related to or describing a status of progress towards the one or more goals. In some embodiments, the one or more selectable answers can be “behind schedule”, or “on track”, or “completed on time”, or “completed early”, or “no longer applies”.

Referring to FIG. 25, in some embodiments, the answers to those questions can populate the manager's review and the employee's self-review, where the goal is to include a conversation around any misalignment around performance and goals. In some embodiments, the information can be displayed as a function of time or time span. In some embodiments, the display page can include a manager and employee's rating. In some embodiments, the display page can include a goal listing. In some embodiments, the display page can include status of employee ratings for a goal. In some embodiments, the display page can include status of a manager rating for a goal. Further, referring to FIG. 26, some system displays can be dedicated to reviewing what is working (e.g., showing accomplishments) and what is not working (e.g., showing areas of improvement).

Referring to FIG. 27, at the end of the year (or at any time or date), the manager augmentation server and system can ask the manager an additional question around each employee's potential. For example, in some embodiments, the manager augmentation server and system can include one or more selectable descriptions or icons of potential, including, but not limited to, “low growth potential”, “moderate growth potential”, and/or “high growth potential”.

Referring to FIG. 28, in some embodiments, an annual review display page can include a rating box chart (shown here with nine ratings) based on previous performance and potential responses, and/or a final goal assessment, and/or final comments around accomplishments, and/or areas of improvement. Further, two criteria, in this case performance and potential, can be used to provide a classification that provides insights into the employee's capabilities and motivations.

FIG. 29 illustrates a direct reports display page according to some embodiments of the invention. In some embodiments, a “my team” page can include a latest performance rating for analysis of both sentiment and performance side by side. In some embodiments, the direct reports display page can include an employee list with title, and/or latest sentiment, and/or last performance, and/or a last sentiment display, and/or a last sentiment date. Further, in some embodiments, the direct reports display page can include a manager's review window for tackling employee and/or team issues that include one or more selectable issues linked to guidance.

FIG. 30 illustrates a dashboard display page according to some embodiments of the invention. In some embodiments, the dashboard can comprise an overview of sentiment, performance, and goal tracking as well as a real-time feed on the right highlighting people at risk, misalignment and other key metrics. In some embodiments, the sentiment overview can comprise a team average display, resolved misalignments display, and/or a sentiment distribution and/or sentiment distribution bar chart. In some embodiments, the performance overview can comprise a team average, and/or goal tracking, and/or performance distribution chart. In some embodiments, a portion of the display can include a window with sentiment summaries and alerts.

FIG. 31 illustrates a tracking and metrics display page according to some embodiments of the invention. In some embodiments, a dashboard can include a summary of metrics around goals, a summary of key metrics, and a list of top performers who are at risk. In this instance, several factors can come together to provide an important insight, where information from sentiments can be correlated with information from performance reviews to determine who should be flagged as a top performer at risk.

In some embodiments, the tracking and metrics display page can include a goal tracking display. In some embodiments, the tracking and metrics display page can include a critical metrics display. In some embodiments, the tracking and metrics display page can include top performers who are at risk display. In some embodiments, a portion of the display can include a window with a summaries and alerts.

FIG. 32 illustrates a summary and performance distribution display page according to some embodiments of the invention. Some embodiments can show a deep analysis with a performance section. In some embodiments, an overview page can show teams with many command and outstanding employees at the top versus teams with those who are struggling, and the bottom chart can show a distribution of the performance ratings by team. In some embodiments, a heat map can be used to visualize performance distribution of employees and/or teams. For example, some embodiments can display a percentage of performance distribution as a function of employee managers. In some embodiments, colors or shades of color can be used to represent various levels or percentages of performance distribution. For example, in some embodiments, one or more colors and/or shades of color can be used to represent performance distribution, and one or more distinct colors and/or shades of color can be used to represent a different percentage of performance distribution. In some embodiments, the heat map can include a representation of performance distribution during a specific time span. For example, the non-limiting embodiment of FIG. 32 shows data representing a quarter. In some embodiments, the heat map can include a representation of a percentage performance distribution for a specific group of employees, a team and/or for an organization.

FIG. 33 illustrates a high and low performing employee display page according to some embodiments of the invention. In some embodiments, the last graph at the bottom of the performance overview section can aggregate all employees at the extremes (high performers versus low performers) enabling human resources teams to work with them accordingly.

FIGS. 34-35 illustrate annual review display pages according to some embodiments of the invention. In some embodiments, the potential page in the performance section shows the box chart aggregated across the company. In some embodiments, by clicking on any box, the manager augmentation server and system can see all the employees that fall into that specific category and their relevant information. In some embodiments, colors or shades of color can be used to represent performance descriptions and/or representations. For example, in some embodiments, one or more colors and/or shades of color can be used to represent a percentage performance descriptions and/or representation, and one or more distinct colors and/or shades of color can be used to represent a different percentages of performance descriptions and/or representations. In some embodiments, the heat map can include a representation of a percentage performance descriptions and/or representations based on job performance and job potential. Further, referring to FIG. 35, if a user clicks on the list view, the user can see what percentage of a manager's team falls in each category. This provides a great calibration tool to ensure that no individual manager has all team members as a future leader or under performer, etc.

FIG. 36 illustrates a performance usage display page according to some embodiments of the invention. The last part under the performance section is usage where the system shows the percentage of managers that have completed their self-reviews and the percentage of individuals that have competed their self-reviews. In some embodiments, colors or shades of color can be used to represent various levels or percentages of usage and/or self-reviews. For example, in some embodiments, one or more colors and/or shades of color can be used to represent a percentage or amount of usage or self-reviews, and one or more distinct colors and/or shades of color can be used to represent a different percentage or amount of usage or self-reviews. In some embodiments, the heat map can include a representation of a percentage or amount of usage during a specific time span.

FIGS. 37-38 illustrate goal overview display pages according to some embodiments of the invention. In some embodiments, if a user clicks on the goal tab, the overview section shows teams with highest and lowest goal tracking usage. The chart at the bottom shows the hierarchy of goals across that manager's organization where they can navigate to anyone's goals on their team and see their goals, the current progress status, etc. Referring to FIG. 38, if a user clicks on the list view, the user can search across all the goals on the team. For example, a user can choose to see all the goals that are “falling behind”, and can work with those managers on those goals.

FIG. 39 illustrates a manage surveys display page according to some embodiments of the invention. In some embodiments, managers can select one, and choose who they want to send it to and when.

FIG. 40 illustrates a scoring and performance statistics display page according to some embodiments of the invention. In some embodiments, the results of surveys can be aggregated, displayed, and analyzed for key insights across the teams and organization. In some embodiments, the display comprises an “ENPS” score. In some embodiments, the scoring and performance statistics display page can include a response rate display, and/or company statistic display, and/or response statistics display. In some embodiments, the scoring and performance statistics display page includes a bar chart data summary for detractors, passives, and promoters represented by one or more distinct colors or shades of color.

In some embodiments, the manager augmentation server and system can function on all devices, including specifically mobile enabled devices. In some embodiments, the manager augmentation server and system can utilize a single sign-on (Okta Browser Plugin, Microsoft® Azure AD) integration, G-suite, Microsoft® Outlook®, HRIS, etc.

In some embodiments, the manager augmentation server and system can generate summary, reminder, and nudge emails. In some embodiments, the manager augmentation server and system can generate quarterly reviews and consulting with dedicated account representatives. In some embodiments, the manager augmentation server and system can include support modes during any time-period. In some embodiments, the manager augmentation server and system can include onboarding, training, and a communications plan.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the description, figures, and claims herein.

In some embodiments, artificial intelligence can be used to provide manager guidance which is implemented in the system as workflow steps known as “To Dos”—see FIG. 41. For example, if a manager has a team member that hasn't been updating their goals for a certain period, a To Do will appear on that manager's dashboard recommending that the manager check-in with that individual on their goals as shown in To Do—FIG. 41-1001. There are many different To Dos for all the different areas described in this application—sentiment, goals, feedback, performance, and surveys. The primary goals are to improve employee happiness and performance, improve team performance and thereby improve manager effectiveness.

In some embodiments, the functionality described here can be implemented as an AI Expert System utilizing Rule-Based technology, but other AI technologies can also be utilized. Specific employee and manager ATTRIBUTES are used to devise an ACTION PLAN that is unique for a manager in dealing with their employees.

In a rule-based implementation, RULES are defined within the Expert System to embody in a computer system the “best practices” of management experts. Rules have two parts, the CONDITION part that triggers the rule and the ACTION PLANS that provide specific manager guidance.

The CONDITION part relies upon attributes that are collected or deduced within the system during normal operation and are associated with employees and/or their manager. Some attributes for employees and managers are listed in the Attributes section below. Attributes may be time based, e.g. biweekly or quarterly, they may be deduced by the system as tasks are completed or not completed, or they may be inferred from trends.

The ACTION PLAN part specifies the specific action plan for the condition(s) triggered. The action plans associated with rules are typically designed to either coach a manager to take specific action(s) with an employee or for a manager to modify their own behavior or techniques. Some action plans are shown in the Action Plans section below.

### Attributes

The system collects employee attributes and manager attributes in the course of its operation and stores in internal storage (see FIG. 10-1028). These attributes include but are not limited to:

| Employee attributes | Manager Attributes |
|---|---|
| Performance - rating | Performance - manager rating |
| Performance - positive/ | Performance - manager positive/ |
| negative comments | negative comments |
| | Performance - rating trend |
| Sentiment - rating | Sentiment - manager rating |
| Sentiment - rating trend | Sentiment - manager rating trend |
| Sentiment - positive/ | Sentiment - manager positive/ |
| | negative reasons |
| negative reasons | Sentiment - at-risk |
| | Sentiment - misalignment |
| Goals - defined | Goals - reviewed |
| Goals - updated | |
| Goals - completion rate | |
| Feedback - shoutouts received | Feedback - shoutouts given to employee |
| Feedback - private received | |
| Feedback - requested | Feedback - requested from employee |
| Agenda - 1 on 1 items created | |
| Surveys - employee satisfaction | |
| | Agenda - 1 on 1 items created |
| | Agenda - 1 on 1 items completed |

### Action Plans

Action Plans are rule actions that can be composed of, but not limited to, management best practices and training materials that address specific situations in employee, manager and/or company interactions. Action plans have been derived from best practices in several management areas.

A representative sample of Action Plans are shown below:
Employee-x has not had a recent 1-on-1 check-in, suggest completing one soon
Employee-x has not received a sentiment rating recently, suggest completing one soon
Employee-x performance check has not been completed, suggest completing it soon
Employee-x, has not updated their goals recently, suggest adding to next 1-on-1 agenda
Employee-x has not completed their goals, suggest adding to next 1-on-1 agenda
Employee-x is not updating their goal status, adding to next 1-on-1 agenda
Employee-x is not completing their goals on a regular basis, recommend adding to next 1-on-1 agenda and assigning a mentor
Most team members have not defined goals, suggest consulting these articles and setting up a team meeting to discuss
You have not provided feedback to employee-x recently, suggest doing so
Employee-x has requested feedback, suggest that you reply soon
Employee-x performance has consistently exceeded expectations, suggest completing a career plan
Employee-x performance consistently exceeds expectations, have you discussed with them recently
Employee-x performance has not met expectations, suggest discussing with them
Employee-x and employee-y have indicated having team issues, suggest reading these articles and setting up a meeting to discuss
Several employees have indicated having team issues, suggest reading these articles and setting up a meeting with team to discuss

In some embodiments, a Net Manager Score™ (also known as NMS) will be calculated and applied to each managers' profile as shown in FIG. 42.

FIG. 42 illustrates the Net Manager Score™ display page according to some embodiments of the invention. In some embodiments, the score is displayed and colored based on the overall score (NMS 1002). In some embodiments, the display comprises a “Trending Up” section which includes the contributors to the overall score and a “Needs Action” section which includes the detractors to the overall score (NMS 1003).

In some embodiments, there is a Net Manager Score Benchmark (FIG. 43) which shows how a manager's score changes over time and compares it to the average of the company (NMS 1004). In some embodiments, the benchmark may include other comparison points such as an industry specific average, a peer average, or an ‘all user’ average.

In some embodiments, there is a Net Manager Score Leaderboard (FIG. 44) which shows the top 10 managers with the highest NMS score (NMS 1005).

In some embodiments, the NMS is calculated by subtracting the number of detractors from the number of contributors, dividing that number by the total number of opportunities, and then multiplying by 100. Contributors are defined as individual goals, feedback, sentiment, and performance triggers that are completed within a specified time period (e.g., one and/or two weeks) after the To Do trigger appears. Detractors are defined as individual goals, feedback, sentiment, and performance triggers that are not completed within a specified time period (e.g., one and/or two weeks) after the To Do trigger appears. Total opportunities are defined as individual goals, feedback, sentiment, and performance triggers added together for a manager's respective team. All managers begin with a score of 100. As To Dos are triggered and then completed or not, their score fluctuates based on ongoing performance.

As used herein, some embodiments recited with term “can” or “may” or derivations there of (e.g., the system display can show X) is for descriptive purposes only and is understood to be synonymous with “configured to” (e.g., the system display is configured to show X) for defining the metes and bounds of the system.

Furthermore, acting as Applicant's own lexicographer, Applicant defines the use of and/or, in terms of “A and/or B,” to mean one option could be “A and B” and another option could be “A or B.” Such an interpretation is consistent with the USPTO Patent Trial and Appeals Board ruling in ex parte Gross, where the Board established that “and/or” means element A alone, element B alone, or elements A and B together.

We claim:

1. A management augmentation system comprising:
an analytical database,
a display, and
one or more computers comprising one or more processors and one or more non-transitory computer readable media, the non-transitory computer readable media comprising instructions stored thereon that when executed by the one or more processors configure the system to:
provide a portal user interface generated on the display and configured to receive input from a user,
provide a machine learning module, and
provide a microservices module comprising at least one application programming interface;
wherein the portal user interface is configured to accept one or more of a goal, a feedback, a sentiment, a performance, and/or survey information and/or display related analytics;
wherein the microservices module is configured to communicate with the portal user interface, the analytical database and/or the machine learning module;
wherein the machine learning module is configured to receive one or more of a goal, a feedback, a sentiment, a performance, and/or survey information from the portal user interface and receive one or more analytics from the analytical database and provide an identification of one or more of an at-risk employee and/or manager, a misaligned employee and/or manager, an under-performing employee and/or manager based on one or more inputs from managers and/or employees;
wherein the identification is displayed on the portal user interface.

2. The management augmentation system of claim 1,
wherein the portal user interface is configured to display the one or more analytics from the analytical database.

3. The management augmentation system of claim 2,
wherein the one or more analytics include a graph of one or more results about the goals, the feedback, the sentiment, the performance, and/or a survey.

4. The management augmentation system of claim 2,
wherein the one or more analytics include one or more action plans, wherein the one or more action plans are from a derivation of best practices from a plurality of management areas.

5. The management augmentation system of claim 4,
wherein the machine learning module is configured to generate the derivation.
